(19) United States
(12) Patent Application Publication
(10) Pub. No.: US 2014/0129336 A1
(43) Pub. Date: May 8, 2014

(54) Targeted Advertising in Conjunction with Consumer Detection

(71) Applicant: Apex Technology Ventures, LLC, Houston, TX (US)

(72) Inventor: Benjamin D. Bailey, Roswell, GA (US)

(21) Appl. No.: 13/973,253

(22) Filed: Aug. 22, 2013

(51) Int. Cl. G06Q 30/02

(52) U.S. Cl. CPC G06Q 30/0261
USPC 705/14.58

(57) ABSTRACT

Described herein are systems, devices, and methods for displaying an advertisement to one or more consumers in proximity to advertising space. The presence of the consumer(s) in proximity to the advertising space can be detected and information associated with the consumer(s) can be received or retrieved. Transaction information can then be transmitted to an auction environment where advertisers can evaluate the transaction information and make determinations as to whether to bid for the advertising space and how much to bid for the advertising space. The winning bidder in the auction may then select and/or transmit an advertisement for display at the advertising space that is tailored to the consumer. In this manner, an advertisement directed at an individual, a group, or a portion of a group may be displayed at the advertising space during a time in which the individual, group, or portion of the group can view the advertisement.

### BACKGROUND OF THE DISCLOSURE

The advertising industry is over a trillion dollar per year industry. Marketers are constantly tweaking existing ad campaigns and looking for new ways to reach potential customers. Placing advertisements in a space likely to be viewed by potential customers is of chief importance. Potential customers are often identified based on demographic information such as age, geographic region, gender, or race. Potential customers can also be identified based on past behavior, such as previous purchases or regular activities.

The more narrowly tailored an ad campaign is to reaching a particular type of consumer, i.e., the more targeted the campaign, the more likely it is that the marketer realizes a satisfactory return on investment. Of critical importance, however, is being able to identify where and when a potential customer is likely to be receptive to viewing an advertisement.

Nowhere are targeted ad campaigns tailored to particular consumers more than on the Internet. When a consumer browses the web, cookies are stored on his or her browser, gathering demographic information related to the consumer and behavioral information, such as what types of websites a consumer visits, how frequently, and whether they purchase particular products over the web.

Thus, when a consumer visits a website that contains ad space, an ad call containing information stored by a cookie can be transmitted by that website, soliciting marketers for their ads. Marketers can then decide, based on the information gathered by the cookie, whether this particular consumer meets a predetermined criteria, and therefore, merits expenditure on the ad space within the website the consumer is about to view. In this manner, marketers are able to spend their marketing resources judiciously and spend money only on ad space likely to be viewed by potential customers.

These types of targeted advertising campaigns are lacking outside of a web browser environment. Advancements in known systems and methods related to physical advertising space have primarily focused on the aggregation of mass consumer data, identifying broadly when and where potential customers are likely to view an advertisement. Many of these advancements, however, rely on market research indicating that mass-communicated advertisements displayed in a particular geographic region at a particular time are likely to be viewed by a potential type or category of customer.

Accordingly, advertising systems and methods could benefit from improved devices and techniques for identifying consumers likely to view a physical advertisement, gathering information regarding those consumers, and allowing marketers to execute a narrower ad campaign focused on potential customers.

### SUMMARY OF THE DISCLOSURE

In accordance with certain embodiments of the present disclosure, systems and methods for displaying an advertisement to a consumer are disclosed. The system may comprise a user identification unit, a display, and an identification unit reader. In some embodiments, the identification unit reader may be configured to receive information stored in the user identification unit when the consumer is in physical proximity to the display. The identification unit reader may be further configured to transmit transaction information to an auction environment and receive an advertisement for display to the consumer.

In one aspect, the transaction information may comprise, for example, information associated with the consumer, the consumer's purchase history, or the consumer's behavior. Additionally or alternatively, transaction information may comprise information associated with the display, the identification unit reader, and/or the auction environment.

In another aspect, advertisers may evaluate the transaction information within the auction environment and bid on advertising space at the display. A determination as to whether to submit a bid and for how much may be based, at least in part, on the transaction information.

In a further aspect, the transaction information may comprise information associated with more than one consumer detected in physical proximity to the display. Where more than one consumer is detected, advertisers may evaluate the transaction information and submit bids for the advertising space in order to place an advertisement at the display that is tailored to one of the consumers, a portion of the consumers, or the entire group.

Additional objects and advantages of the present disclosure will be set forth in part in the description which follows, and in part will be obvious from the description, or may be learned by practice of the disclosure. The objects and advantages of the disclosure will be realized and attained by means of the elements and combinations particularly pointed out in the appended claims.

It is to be understood that both the foregoing general description and the following detailed description are exemplary and explanatory only and are not restrictive of the claims.

The accompanying drawings, which are incorporated in and constitute a part of this specification, illustrate several embodiments and together with the description, serve to explain the principles of the disclosure.

### BRIEF DESCRIPTION OF THE DRAWINGS

FIG. 1 depicts some aspects of an exemplary embodiment of a system as described herein.

FIG. 2 depicts an exemplary embodiment of a computing system as described herein.

FIG. 3 depicts some aspects of an exemplary embodiment of a system as described herein.

FIG. 4 depicts some aspects of an exemplary embodiment of a system as described herein.

FIG. 5 depicts some aspects of an exemplary embodiment of a system as described herein.

FIG. 6 depicts some aspects of an exemplary embodiment of a method as described herein.

FIG. 7 depicts some aspects of an exemplary embodiment of a method as described herein.

FIG. 8 depicts some aspects of an exemplary embodiment of a system as described herein.

FIG. 9 depicts some aspects of an exemplary embodiment of a system as described herein.

FIG. 10 depicts some aspects of an exemplary embodiment of a system as described herein.

FIG. 11 depicts some aspects of an exemplary embodiment of a system as described herein.

### DESCRIPTION OF EXEMPLARY EMBODIMENTS

Disclosed herein are various embodiments of an advertising system. Generally, the system can detect the presence of a consumer in physical proximity to an advertising space, gather information pertaining to the consumer, present that information to multiple marketers, and display an advertisement from a marketer that places the highest value on the consumer at the advertising space. Currently employed systems rely on mass market research, indicating when and where likely customers will be receptive to viewing a physical advertising space. Decisions to purchase the physical advertising space for display of an advertisement to consumers are made based on the mass market research. Thus, if the mass market research indicates that a billboard along a highway is likely to be viewed by suburban professionals on weekdays between the hours of 7:00 am and 9:00 am, an advertiser targeting that demographic may purchase the advertising space for the display of an advertisement on those days and between those hours. In order to increase revenue, the owner of the billboard may require the same advertiser to purchase the advertising space for display of an advertisement outside the ideal day and time window wherein a potential customer is likely to view the advertisement.

Thus, current systems are not ideally suited to display advertisements tailored to one or more particular consumers presently viewing the advertising space. Further, current systems are not configured to maximize revenue generated by billboard owners for their advertising space, nor maximize a marketer's return on investment when purchasing the advertising space.

The systems disclosed herein solve these problems by introducing elements of consumer presence detection, demographic and behavior information collection, and the facilitation of real-time transactions for the display of advertisements at advertising space within view of the detected consumer. Moreover, in situations where more than one consumer is within view of the advertising space, marketers can decide, in real-time, whether to display an advertisement targeting one of the consumers within a group, or display an advertisement targeted at the group as a whole or some subset of the group.

While the systems and methods described herein are primarily concerned with real-time auctions for the purchase of advertising space, one skilled in the art will appreciate that the systems and methods described below can be used in other contexts, including scenarios in which the price for advertising at an advertising space is predetermined and/or the marketer displaying the advertisement at the advertising space is pre-selected.

Reference will now be made in detail to certain exemplary embodiments, examples of which are illustrated in the accompanying drawings. Wherever possible, the same reference numbers will be used throughout the drawings to refer to the same or like items.

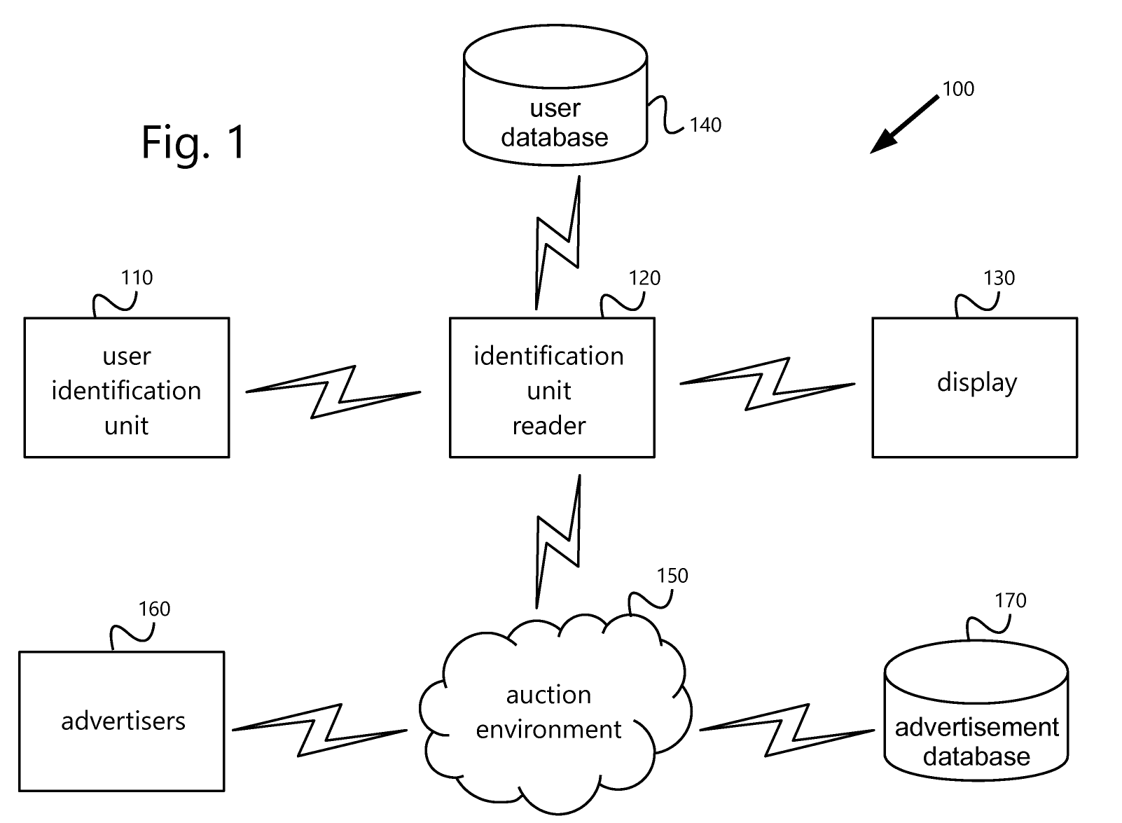

FIG. 1 illustrates one exemplary embodiment of an advertising system 100. System 100 can comprise a user identification unit 110, an identification reader 120, and a display 130. User identification unit 110, identification reader 120, and display 130 can be configured for one or more of storing, receiving, transmitting, and displaying information.

In one embodiment, user identification unit 110 can be an RFID tag storing information associated with a user and may be further configured to receive and transmit the information associated with the user. In other embodiments, user identification unit 110 can be any processor- or controller-based device for storing, receiving, and transmitting information associated with a user. For example, identification unit 110 can be a user's cell phone, smart phone, tablet, laptop, or personal computer. Other examples of identification unit 110 include any portable, processor- or controller-based device such a device built into a user's vehicle, e.g., a GPS unit. The aforementioned examples of identification unit 110 are only exemplary and should not be construed as an exhaustive list. Additional examples of user identification unit 110 are discussed below.

In another aspect, user identification unit 110 can be any unit the location of which at a particular time is indicative of the user's location at that time. In other words, user identification unit 110 can be an RFID tag carried on the user's person. Alternatively, user identification unit can be a processor- or controller-based device either on the user's person, carried by the user, or incorporated into a vehicle carrying the user. Other embodiments are also possible and should be obvious in light of this disclosure.

In a further aspect, user identification unit 110 can be configured to store information associated with a user. For example, user identification unit 110 can store personal, demographic, and/or historical data associated with a user. In one embodiment, user identification unit 110 can store a user's name and a user identification number. In other embodiments, user identification unit 110 can also store information related to a user's age, gender, and/or ethnicity. In further embodiments, user identification unit 110 can also store information related to a user's past purchase history, a mailing address, and/or a current location. In instances where the user identification unit 110 is equipped with GPS or another geographic location or mapping system for example, user identification unit 110 may also contain information pertaining to where a user has recently traveled and/or a user's destination.

Identification unit reader 120, similar to user identification unit 110, can be configured to store, receive, and transmit information. In one embodiment, identification unit reader 120 can be an RFID reader configured to store, receive, and/or transmit information. In other embodiments, identification unit reader 120 can be any processor- or controller-based device for storing, receiving, and transmitting information. For example, identification unit reader 120 can be a cell phone, smart phone, tablet, laptop, or personal computer. Other examples of identification unit reader 120 include any portable or non-portable, processor- or controller-based device. Additional examples of identification unit reader 120 are discussed below.

In one aspect, user identification unit 110 and identification unit reader 120 can be in communication with one another and configured to exchange information. Devices 110 and 120 can be in one-way or two-way communication, and can be wire- or wirelessly-connected. In some embodiments, devices 110 and 120 can communicate via an RF communication channel. In other embodiments, devices 110 and 120 can communicate via a near-field, Bluetooth, Internet, network, or wi-fi communication channel. In further embodiments, devices 110 and 120 can communicate over some other wireless communication channel or a wired communication channel.

In another aspect, system 100 may further comprise a display 130. Display 130 can comprise any device configured for displaying an advertisement to a user. Like user identification unit 110 and identification unit reader 120, display 130 can further be configured to store, receive, transmit, and display information. In one embodiment, display 130 can comprise a video or television monitor. In other embodiments, display 130 can comprise an electronic billboard. In further embodiments, display 130 can comprise any portable or non-portable, processor- or controller-based device for displaying an image to a user. For example, display 130 can be a user's cell phone, smart phone, tablet, laptop, or a wearable display device (as discussed below). Of course, the example provided here are exemplary only and should not be construed as an exhaustive list.

In a further aspect, display 130 and identification unit reader 120 can be in communication with one another and configured to exchange information. Display 130 and identification unit reader 120 can be in one-way or two-way communication, and can be wire- or wirelessly-connected. In some embodiments, display 130 and identification unit reader 120 can communicate via an RF communication channel. In other embodiments, display 130 and identification unit reader 120 can communicate via a near-field, Bluetooth, Internet, network, or wi-fi communication channel. In further embodiments, display 130 and identification unit reader 120 can communicate over some other wireless communication channel or a wired communication channel. Moreover, display 130 may be configured to communicate directly with user identification unit 110 in a manner similar to that described above with respect to identification unit reader 120. In an alternative embodiment, identification unit reader 120 and display 130 can be incorporated into a single device configured for communication with user identification unit 110.

FIG. 1 further depicts a user database 140 in communication with identification unit reader 120. In particular, database 140 and identification unit reader 120 can be configured to exchange information. In one aspect, database 140 and identification unit reader 120 can be in one-way or two-way communication, and can be wire- or wirelessly-connected. In some embodiments, database 140 and identification unit reader 120 can communicate via an RF communication channel. In other embodiments, database 140 and identification unit reader 120 can communicate via a near-field, Bluetooth, Internet, network, or wi-fi communication channel. In further embodiments, database 140 and identification unit reader 120 can communicate over some other wireless communication channel or a wired communication channel.

In another aspect, database 140 can be further configured to communicate with user identification unit and/or display 130 in a manner similar to that described above with respect to identification unit reader 120. Database 140 can also be incorporated into any one or more of user identification unit 110, identification unit reader 120, and display 130.

In a further aspect, database 140 can be configured to store information associated with a user, information associated with identification unit reader 120, and/or information associated with display 130. For example, database 140 can store personal, demographic, and/or historical data associated with a user. In one embodiment, user display 140 can store a user identification number associated with other information pertaining to the user. For example, display 140 can store information related to a user's age, gender, and/or ethnicity. In further embodiments, display 140 can also store information related to a user's past purchase history, a mailing address, and/or a current location. In this manner, where identification unit reader 120 can provide a user identification number or some other identifying information from user identification unit 110, database 140 can be used to store various types of information pertaining to the user and associated with the user's identification number or other identifying information.

In another aspect, database 140 may further be configured to store information pertaining to the identification unit reader and/or display 130. For example, database 140 may store information related to the location of one or both of identification unit reader 120 and display 130. In an alternative embodiment, database 140 can also store information pertaining to display 130 that would facilitate the selection of an advertisement at display 130, such as the size of display 130, its proximate distance from a user, how much consumer traffic display 130 is exposed to in an hour, day, week, or some other time period, and/or data indicating how effective display 130 has been at influencing consumers' behavior. In further embodiments, database 140 can be configured to store any information deemed necessary or helpful by advertisers using system 100 or for the implementation of system 100.

System 100 may further comprise a real-time auction environment 150. Real-time auction environment 150 may be hosted in the cloud or in a network of one or more servers. Alternatively, real-time auction environment 150 can be maintained locally within a closed network comprising identification unit reader 120, display 130, and/or database 140. In other embodiments, auction environment 150 can be incorporated into identification unit reader 120, display 130, and/or database 140.

In one aspect, auction environment 150 can be in communication with identification unit reader 120. In particular, auction environment 150 and identification unit reader 120 can be configured to exchange information. For example, auction environment 150 and identification unit reader 120 can be in one-way or two-way communication, and can be wire- or wirelessly-connected. In some embodiments, auction environment 150 and identification unit reader 120 can communicate via an RF communication channel. In other embodiments, auction environment 150 and identification unit reader 120 can communicate via a near-field, Bluetooth, Internet, network, or wi-fi communication channel. In further embodiments, auction environment 150 and identification unit reader 120 can communicate over some other wireless communication channel or a wired communication channel.

In alternate embodiments, auction environment 150 is also in communication with one or more of user identification unit 110, display 130, and database 140. The communication channels between the various components of system 100 can be similar to those described above with respect to the other components.

In one aspect, auction environment 150 can facilitate the sale and placement of advertisements at display 130. In one embodiment, auction environment 150 can be a modified Vickrey auction in which the winning bidder pays the price bid by a second place bidder plus one cent for the placement of an advertisement at display 130. In other embodiments, auction environment 150 can be a Vickrey auction, a sealed first-price auction, or a Dutch auction. In further embodiments, an English auction can be used or any other suitable auction style.

Also in communication with auction environment 150 are advertisers 160. Advertisers 160 can comprise one or more advertising or marketing entities whose aim is to purchase advertising space and/or place advertisements before consumers. In one embodiment, advertisers are in direct communication with auction environment 150. In other embodiments, marketing aggregators or third parties charged with conducting marketing campaigns on behalf of one or more advertisers may be in communication with auction environment 150. In one aspect, as advertising space at display 130 is submitted to auction environment 150 through any one or more of user identification unit 110, identification unit reader 120, display 130, and database 140, advertisers 160 (or their surrogates) can place bid on the advertising space. In another aspect, and as discussed in more detail below, the offer of advertising space to auction environment 150 can be triggered by the approach of a user toward display 130. In a further aspect, information associated with the user and contained in one or both of user identification unit 110 and database 140 can be transmitted with the offer. In still further aspects, additional information pertaining to system 100, including information associated with identification unit reader 120, display 130, and database 140 can be transmitted with the offer. In alternative embodiments, other information can be transmitted with the offer.

FIG. 1 further depicts advertisement database 170. Advertisement database 170 can comprise all advertisements that can be displayed at display 130. For example, advertisers 160 participating in system 100 can store one or more advertisements at database 170. In addition to the advertisements, advertisement database 170 can also store advertiser identification numbers and/or advertisement numbers associated with the advertisements. In this manner, when a winning bidder is selected at auction environment 150, the winning bidder can be easily identified and information regarding which advertisement to display at display 130 can be quickly transmitted.

Communication between advertisement database 170 and the other components of system 100 can be accomplished in manners similar to those described above with respect to communication between other components of system 100. Further, while FIG. 1 depicts advertisement database 170 in communication with auction environment 150, advertisement database 170 can be in direct or indirect communication with any one or more of user identification unit 110, identification unit reader 120, display 130, database 140, auction environment 150, and advertisers 160.

In one embodiment, advertisement database 170 can be maintained in the cloud or in a network of one or more servers. Alternatively, advertisement database 170 can be maintained locally within a closed network comprising one or more of identification unit reader 120, display 130, database 140, and advertisers 160. In other embodiments, advertisement database 170 can be incorporated into any one of user identification unit 110, identification unit reader 120, display 130, database 140, auction environment 150, and advertisers 160.

As discussed in further detail below, and in practice, identification unit reader 120 can capture information pertaining to a user in proximity to display 130, transmit this information to auction environment 150, receive bids from one or more advertisers interested in placing an advertisement at display 130 directed at the user, receive an advertisement from the winning bidder, and display the advertisement at display 130 to the user. As used herein, the term “proximity” is meant to describe a relative physical closeness. Depending upon the environment (some of which are discussed below), proximity may mean within the same room, within the same building or some other structure, or within a line of sight. Proximity may also be determined based on a distance. For example, in some embodiments, proximity may mean within two miles. Alternatively, proximity may encompass distances less than or greater than two miles.

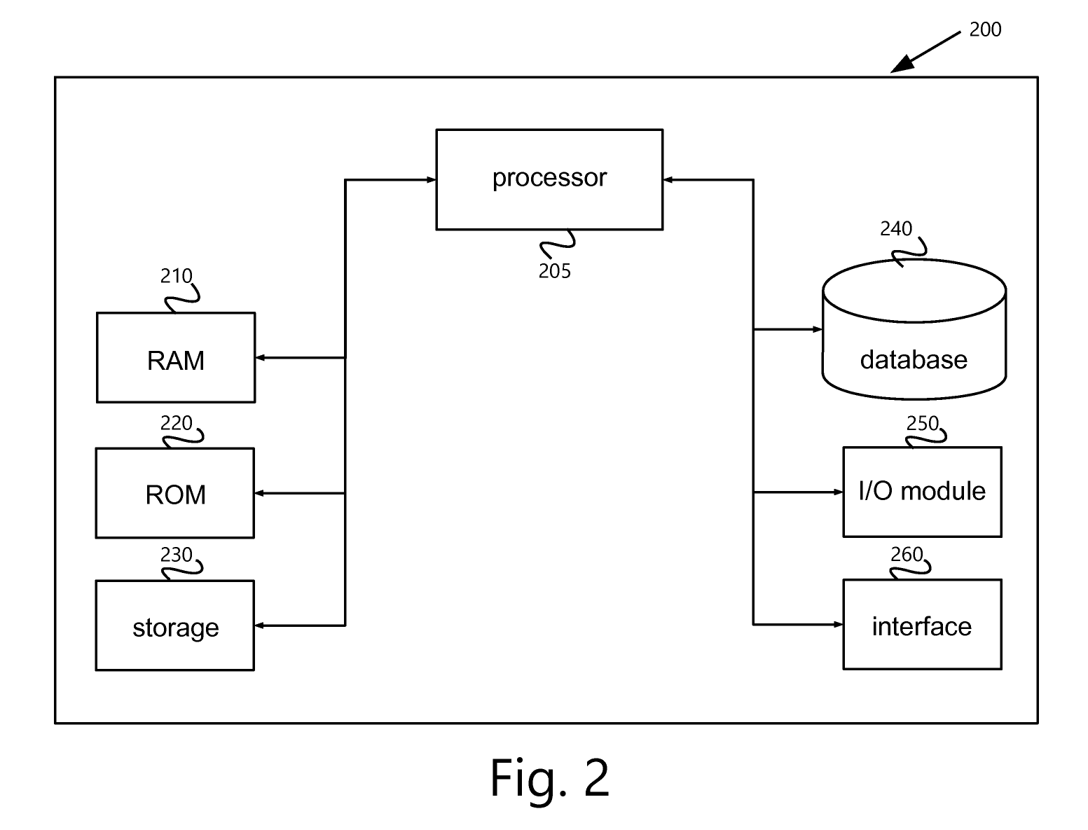

FIG. 2 depicts an exemplary processor-based computing system 200 representative of the type of computing system that may be present in or used in conjunction with any one or more of user identification unit 110, identification unit reader 120, display 130, database 140, auction environment 150, advertisers 160, and advertisement database 170. The computing system 200 is exemplary only and does not exclude the possibility of another processor- or controller-based system being used in or with one of the aforementioned components.

In one aspect, system 200 may include one or more hardware and/or software components configured to execute software programs, such as software for storing, processing, and analyzing data. For example, system 200 may include one or more hardware components such as, for example, processor 205, a random access memory (RAM) module 3210, a read-only memory (ROM) module 220, a storage system 230, a database 240, one or more input/output (I/O) modules 250, and an interface module 260. Alternatively and/or additionally, system 200 may include one or more software components such as, for example, a computer-readable medium including computer-executable instructions for performing methods consistent with certain disclosed embodiments. It is contemplated that one or more of the hardware components listed above may be implemented using software. For example, storage 230 may include a software partition associated with one or more other hardware components of system 200. System 200 may include additional, fewer, and/or different components than those listed above. It is understood that the components listed above are exemplary only and not intended to be limiting.

Processor 205 may include one or more processors, each configured to execute instructions and process data to perform one or more functions associated with system 200. The term “processor,” as generally used herein, refers to any logic processing unit, such as one or more central processing units (CPUs), digital signal processors (DSPs), application specific integrated circuits (ASICs), field programmable gate arrays (FPGAs), and similar devices. As illustrated in FIG. 2, processor 205 may be communicatively coupled to RAM 210, ROM 220, storage 230, database 240, I/O module 250, and interface module 260. Processor 205 may be configured to execute sequences of computer program instructions to perform various processes, which will be described in detail below. The computer program instructions may be loaded into RAM for execution by processor 205.

RAM 210 and ROM 220 may each include one or more devices for storing information associated with an operation of system 200 and/or processor 205. For example, ROM 220 may include a memory device configured to access and store information associated with system 200, including information for identifying, initializing, and monitoring the operation of one or more components and subsystems of system 200. RAM 210 may include a memory device for storing data associated with one or more operations of processor 205. For example, ROM 220 may load instructions into RAM 210 for execution by processor 205.

Storage 230 may include any type of storage device configured to store information that processor 205 may need to perform processes consistent with the disclosed embodiments.

Database 240 may include one or more software and/or hardware components that cooperate to store, organize, sort, filter, and/or arrange data used by system 200 and/or processor 205. For example, database 240 may include user-specific account information, predetermined menu/display options, and other user preferences. Alternatively, database 240 may store additional and/or different information.

I/O module 250 may include one or more components configured to communicate information with a user associated with system 200. For example, I/O module 250 may include a console with an integrated keyboard and mouse to allow a user to input parameters associated with system 200. I/O module 250 may also include a display including a graphical user interface (GUI) for outputting information on a monitor. I/O module 250 may also include peripheral devices such as, for example, a printer for printing information associated with system 200, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 260 may include one or more components configured to transmit and receive data via a communication network, such as the Internet, a local area network, a workstation peer-to-peer network, a direct link network, a wireless network, or any other suitable communication platform. For example, interface 260 may include one or more modulators, demodulators, multiplexers, demultiplexers, network communication devices, wireless devices, antennas, modems, and any other type of device configured to enable data communication via a communication network.

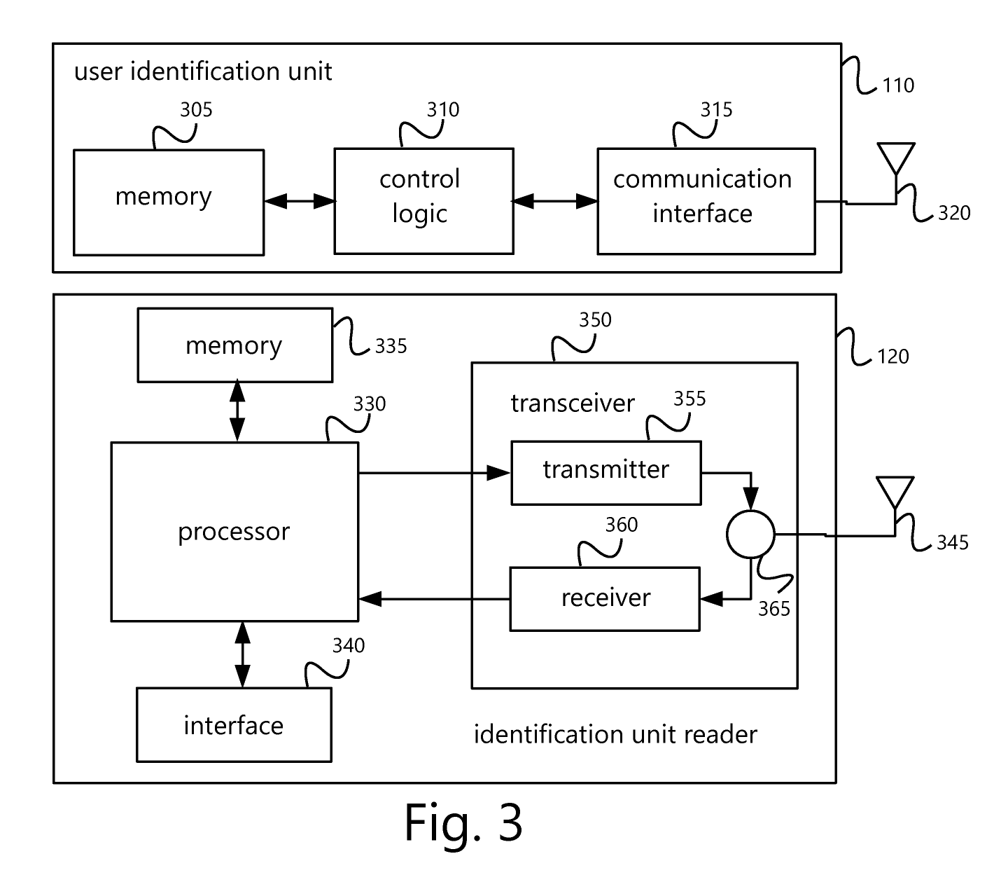

FIG. 3 depicts one exemplary embodiment of user identification unit 110 and identification unit reader 120, wherein reader 120 may be an RFID reader and identification unit 110 may be an RFID tag.

In one aspect, reader 120 may comprise a processor 330, a memory 335, an interface 340, and a transceiver 350. Processor 330 may be substantially similar to the processor described above with respect to FIG. 2, and can be configured to receive and process data signals recovered from user identification unit 110 via an antenna 345. Processor 330 can be further configured to communicate any signals received from user identification unit 110 with other systems and/or components, such as one or more of display 130, database 140, auction environment 150, advertisers 160, and advertisement database 170 via antenna 345 or interface 340. Alternatively, processor 330 can be configured to communicate received signals to systems and/or components outside of system 100.

Memory 335 may include one or both of a random access memory (RAM) and a read-only memory (ROM) which can provide storage for program instructions, parameters, and data for processor 330. In one embodiment, memory 335 can contain instructions that can be executed by processor 330 to cause the processor to receive, write, and/or manipulate data transmitted by user identification unit 110. Memory 335 may further comprise a flash memory or electronically erasable programmable read-only memory (EEPROM).

In another aspect, reader 120 may further comprise additional peripheral systems at interface 340 such as a display, keyboard, printer, fixed memory storage device, and/or other peripherals in communication with processor 330.

Transceiver 350 can be configured to facilitate one-way or two-way RF communication between reader 120 and user identification unit 110 under the control of processor 330. In one aspect, transceiver 350 may comprise a transmitter 355, a receiver 360, and a hybrid 365. Hybrid 365 can be coupled to antenna 345. Hybrid 365 can also connect transmitter 355 and receiver 360 to antenna 345 while isolating them from each other. In this manner, hybrid 365 can allow antenna to transmit a strong signal from transmitter 355 and receive a weak back-scattered signal reflected from user identification unit 110. In some embodiments, hybrid 365 may further comprise a circulator, directional coupler, or some similar component facilitating bi-directional communication of signals between reader 120 and user identification unit 110 with sufficient signal isolation.

In another aspect, transmitter 355 may comprise a local oscillator configured to generate an RF carrier frequency. In use, transmitter 355 can send a transmission signal modulated by the RF carrier frequency to hybrid 365, which can then pass the signal to antenna 345. Antenna 345 may then broadcast the modulated signal and capture any signal radiated by user identification unit 110. For example, antenna 345 may broadcast a “wake-up” signal to user identification unit 110, which then responds by broadcasting data stored in identification unit 110 back to reader 120.

In a further aspect, antenna 345 can pass any signals captured from user identification unit 110 back to hybrid 365, which can forward the signal to receiver 360 and processor 330.

Of course, the aforementioned embodiments of reader 120 are exemplary only. It should be appreciated that any known embodiment for a suitable RFID reader can be utilized within the present disclosure. Alternatively, identification unit reader 120 can comprise another type of reader that does not rely on RF transmission, as discussed above and below with respect to other embodiments.

As further depicted in FIG. 3, user identification unit 110 can be an RFID tag comprising a memory 305, a control logic 310, a communication interface 315, and an antenna 320. Communication interface 315 can be coupled to antenna 320, and may include a transceiver for transmitting and receiving RF signals. The transceiver may further comprise a modulator adapted to backscatter modulate the impedance match with the antenna in order to transmit data signals by reflecting a continuous wave (CW) signal provided by identification unit reader 120.

Control logic 310 can control the functions of user identification unit 110 in response to commands provided by identification unit reader 120 that may be embedded in a received RF signal. Control logic 310 can also be configured to access memory 305 to read and/or write data therefrom. Control logic 310 can also convert analog data signals recovered by interface 315 into digital signals comprising the received commands, and can convert digital data retrieved from memory 305 into analog signals that are backscatter modulated by interface 315.

In a further aspect, user identification unit 110 may be adapted to derive electrical power from an interrogating signal transmitted by identification unit reader 120. Alternatively, user identification unit 110 may comprise its own power source.

Like identification unit reader 120, the aforementioned embodiments of user identification unit 110 are exemplary only. It should be appreciated that any known embodiment for a suitable RFID tag can be utilized within the present disclosure. Alternatively, user identification unit 110 can comprise another type of device that does not rely on RF transmission, as discussed above and below with respect to other embodiments.

In one aspect, reader 120 may be configured to read data stored in user identification unit 110 automatically as user identification unit 110 comes into proximity with reader 120. In one embodiment, such reading can be performed without any physical intervention by a user. In other words, in an embodiments where user identification unit 110 is carried by a user, accompanies the user, or is incorporated into a vehicle carrying the user, reader 120 and identification unit 110 can engage in one- or two-way communication any time the user comes near reader 120, without any action being required by the user. In some embodiments, reader 120 may be configured such that it is in a constant “ready” state in which it periodically transmits an interrogation signal to determine if one or more user identification units 110 have been brought into proximity. In alternative embodiments, reader 120 can be selectively enable and/or disabled, for example in order to preserve battery power during periods of non-use. In still further embodiments, reader 120 may be coupled to a motion sensor through interface 340 that activates reader 120 when movement is detected. Thus, reader 120 can be kept in a disabled or “sleep” mode until the nearby movement of a potential user is detected, at which time reader 120 can switch to a ready state and transmit an interrogation signal to any nearby user identification units 110.

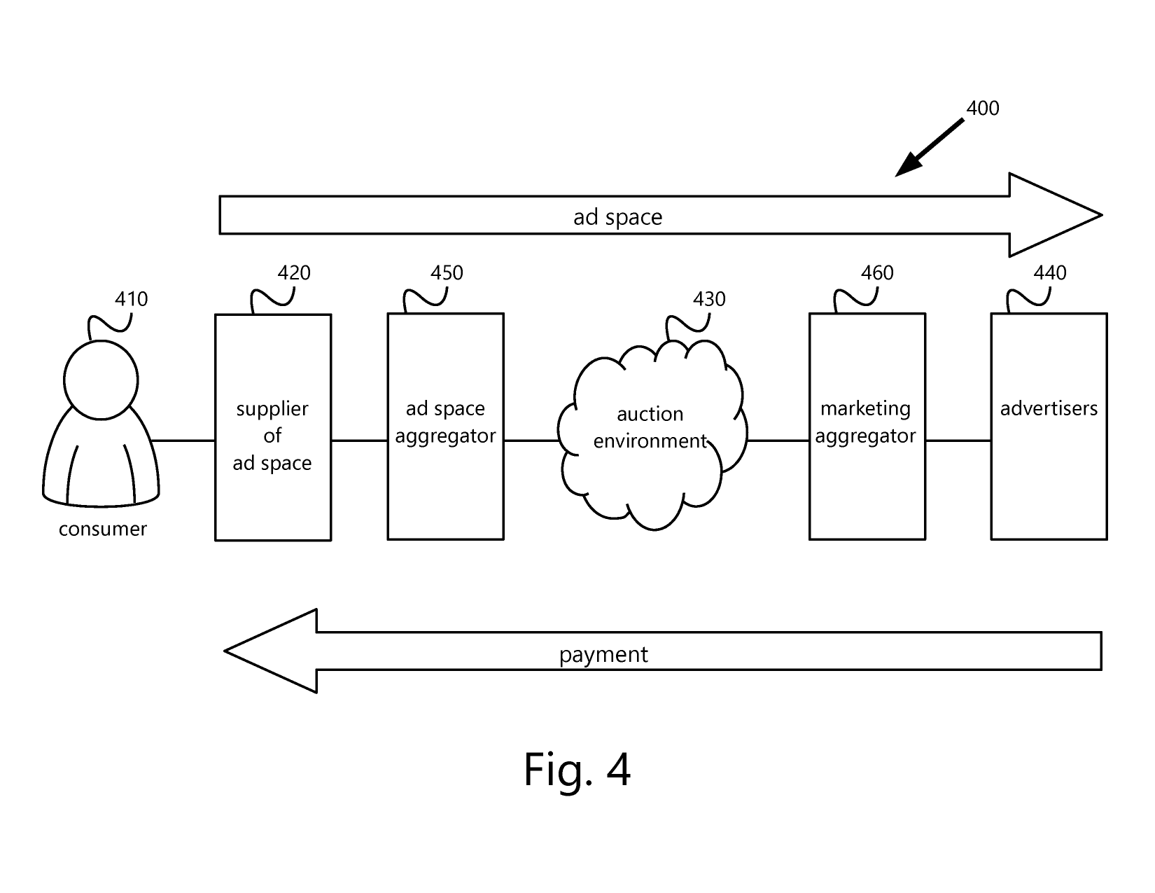

FIG. 4 depicts an exemplary environment 400 for facilitating the sale of physical advertising space by an owner of the advertising space to an advertiser. In particular, the flow of available advertising space from a supplier to an advertiser, as well as the flow of compensation from the advertiser back to the supplier is generally depicted. In one aspect, environment 400 can comprise a consumer 410, a supplier of physical advertising space 420, a real-time auction environment 430, and one or more advertisers 440. As discussed previously, supplier 420 can detect the presence of consumer 410 in the vicinity of advertising space controlled by supplier 420, and make that advertising space available for purchase through auction environment 430. Detection of consumer 410 can be accomplished in a number of ways and any suitable method can be used. When supplier 420 makes the advertising space available for auction may also depend, at least in part, on how and where consumer 410 is detected. For example, the presence of consumer 410 can be detected when consumer 410 is within a line of sight of the advertising space. In such embodiments, supplier 420 may make the advertising space available for auction immediately upon detection of consumer 410 or after some predetermined length of time. In other embodiments, supplier 420 may continue to monitor the location of consumer 410 and make the advertising space available for auction when or after particular criteria are met. For example, supplier 420 may not make the advertising space available for auction until consumer 410 is some predetermined distance from the advertising space.

Alternatively, the presence of consumer 410 can be detected at a location in proximity to the advertising space but not within a line of sight of the advertising space, or at a location from which consumer 410 is likely to come within a line of sight of the advertising space. In such embodiments, supplier 420 may immediately make the advertising space available for auction or may delay making the advertising space available for some predetermined amount of time. For example, where consumer 410 is detected a distance away from the advertising space, supplier 420 may delay making the advertising space available for auction until after some amount of time has passed likely to coincide with how long it may take consumer 410 to come within a line of sight of the advertising space. Alternatively, the advertising space can be made available for auction at some time before or after consumer 410 is likely to come within a line of sight of the advertising space. In other embodiments, supplier 420 may continue to monitor the location of consumer 410 and make the advertising space available for auction after it has been confirmed that consumer 410 is approaching the advertising space.

In further embodiments, the behavior of consumer 410 can be monitored and the advertising space may not be made available for auction until a determination is made that consumer 410 is likely to come within a line of sight of the physical advertising space. In such embodiments, the advertising space may be made available for auction at, before, or after such a determination is made.

Other embodiments and methods for both detecting the presence of consumer 410 and determining when to make the advertising space available for auction may also be appropriate and should be obvious in light of this disclosure.

In another aspect, after a determination has been made to make the advertising space available for auction, transaction information regarding consumer 410, supplier 420, the advertising space, and other relevant information can be transmitted to auction environment 430. In one embodiment, supplier 420 can transmit transaction information directly to auction environment 430. In other embodiments, supplier 420 may transmit transaction information to an advertising space aggregator 450. Advertising space aggregator 450 may, for example, aggregate advertising space supply from more than one supplier and transmit a portion or all of the advertising space received to auction environment 430. Transaction information may be transmitted in the form of a recognized or predetermined protocol or sequence such that one or more parties privy to auction environment 430 can make use of the transaction information. Auction environment 430 may also operate according to an agreed upon standard that all parties privy to environment 430 have adopted.

Once the transaction information is made available within auction environment 430, one or more advertisers may review the transaction information and submit bids for purchasing the advertising space associated with consumer 410. A determination regarding how much to bid for particular advertising space in view of a particular consumer can be handled on a case-by-case basis or according to predetermined algorithms constructed by each advertiser. For example, if advertiser 440 is in the business of selling products known to be purchased by consumer 410, advertiser 440 may submit higher bids for advertising space in proximity to consumer 410 as compared to advertising space in proximity to other consumers. In particular, in one embodiment, advertiser 440 may have algorithms for weighting one or more data items from the transaction information according to a predetermined scale developed to identify consumers most likely to be interested in the advertiser's product(s). In such an embodiment, transaction information associated with consumers that match one or more customer profiles developed by advertiser 440 may trigger a bid on behalf of the advertiser for the advertising space associated with that transaction information. Depending on an advertiser's evaluation of the transaction information associated with a particular consumer, the bid for the advertising space may vary.

In other embodiments, transaction information may indicate the presence of more than one consumer in proximity to the advertising space. In such situations, advertiser 440 may submit a bid to place an advertisement within view of the group of consumers, but targeted at one or more of the detected consumers from among the group. Alternatively, advertiser 440, upon receiving transaction information indicative of more than one consumers in proximity to the advertising space, may aggregate information regarding each consumer and submit a bid to place an advertisement within view of the group of consumers, and targeting the group as a whole or a portion of the whole.

After bids for the advertising space are submitted by one or more advertisers, a winning bid may be selected. In one embodiment, an auction for particular advertising space may remain open to the submission of bids for a predetermined amount of time. For example, an auction may remain open to the submission of bids for 5 seconds or some other amount of time shorter or longer than 5 seconds. In some embodiments, an auction may remain open for the submission of bids for only a fraction of a second, or for one or more minutes.

In other embodiments, how long the auction may remain open for the submission of bids may depend, at least in part, upon the method and devices used to detect consumer 410 and/or when the advertising space was made available for auction by supplier 420. For instance, where the advertising space was made available for auction when consumer 410 was first detected in proximity to the advertising space, the auction may remain open for the submission of bids until a predetermined time when it is likely the consumer is within a line of sight of the advertising space. Alternatively, the auction may remain open for the submission of bids until it is confirmed that consumer 410 is within a line of sight of the advertising space.

After the auction has closed, a winning bidder may be determined. The price the winning bidder pays for the adverting space may depend, at least in part, on the amount the winning bidder and/or other bidders bid at the auction. In one embodiment, a modified Vickrey auction may be conducted in which the winning bidder pays the price bid by a second place bidder plus one cent. In other embodiments, a Vickrey auction, a sealed first-price auction, a Dutch auction, an English auction, or any other suitable auction style can be used.

A payment for the advertising space can then be scheduled by the winning bidder. For example, a predetermined financial account of the winning bidder may be automatically debited upon the determination that the winning bidder has won the auction. Alternatively, payment to the supplier (or ad space aggregator, where applicable) for the advertising space won at auction can be scheduled for some time in the future. In further embodiments, the winning bidder may have prepaid some amount to be placed towards winning bids. In such an embodiment, upon a determination that the winning bidder has won the auction, the prepaid amount will be debited to reflect the purchase at auction. Other suitable methods for facilitating payment to supplier 420 by advertiser 440 are also possible.

In other embodiments of environment 400, rather than advertisers 440 directly submitting bids at auction 430, bids may be placed at auction 430 by one or more marketing aggregators 460. Marketing aggregators 460 may, for example, aggregate advertising demand from one or more advertisers 440 and facilitate the purchase of advertising space on those advertisers' behalf. In other embodiments, both advertisers 440 and marketing aggregators 460 submit bids to auction 430.

Before, during, or after the schedule of payment to supplier 420 by advertiser 440 (or some party acting on behalf of advertiser 440) for the advertising space, a request can be sent by supplier 420 (or advertising space aggregator) to advertiser 440 (or marketing aggregator 460) to supply the advertisement for display at the advertising space. In one embodiment, an advertiser 440 (or marketing aggregator 460) may transmit the advertisement for display at the advertising space. In other embodiments, an advertiser 440 (or marketing aggregator 460) may transmit identifying information, including a location of the advertisement and an advertisement identification number. For example, identifying information may contain information regarding a database in which the advertisement is contained and an identification number unique to the advertisement within the database. As discussed previously, the database can be any database within or outside environment 400, maintained locally by a party to the transaction or maintained in the cloud.

In alternative embodiments, which advertisement to display at the advertising space may be predetermined. For example, an advertiser 440 (or marketing aggregator 460) may elect to display a particular advertisement every time it wins an auction. In another embodiment, an advertiser 440 (or marketing aggregator 460) may create multiple identities for bidding within auction environment 430 and which advertisement is displayed at the advertising space depends, at least in part, on which of the advertisers' identities won the auction. Of course, other suitable methods for determining an advertisement for display at the advertising space are possible and should be obvious in light of this disclosure.

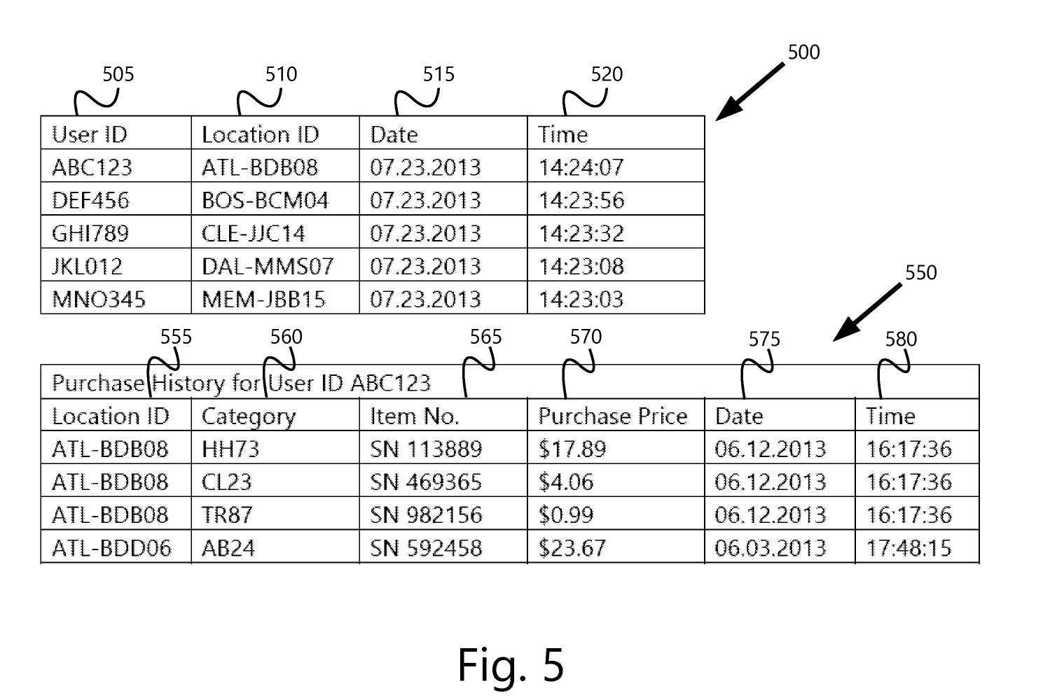

FIG. 5 depicts examples of transaction information 500 transmitted by supplier 420 (or advertising space aggregator 450) to auction environment 430. In one aspect, transaction information 500 can comprise a user identification 505, a location identification 510, a date 515, and a time 520. Transaction information 500 may also contain information regarding the display at which an advertisement is to be display, such as medium, size, location, and/or formatting information. Transaction information 500 may also contain other information helpful to an advertiser 440 (or marketing aggregator 460) when evaluating advertising space for purchase and the examples provided herein should not be construed as exhaustive of the various possibilities.

Transaction information 500 may be transmitted in the form of a recognized or predetermined protocol or sequence such that one or more parties privy to auction environment 430 can make use of transaction information 500. Auction environment 430 may also operate according to an agreed upon standard that all parties privy to environment 430 have adopted. In one embodiment, identifications 505, 510, 515, 520, and/or any other identifications contained in transaction information 500 can be an alphanumeric character string of any suitable length. In other embodiments, some other identification system can be used.

In another aspect, transaction information 500 can be used by advertisers 440 (or marketing aggregators 460) to make a determination as to whether to bid for advertising space associated with transaction information 500 and, if so, how much to bid. For example, advertiser 400 may desire to place an advertisement before any consumer that appears at a particular location, on a particular date, at a particular time. Alternatively, advertiser 400 may desire to place an advertisement before any consumer on a particular date without regard to the location and/or time. Of course, these examples are not exhaustive and numerous possible combinations of data should be obvious in light of this disclosure.

Advertiser 400 may also desire to place an advertisement before a particular consumer associated with user identification 505, regardless of where or when that consumer is in proximity to the advertising space. Alternatively, advertiser 400 may only desire to place advertisements before a consumer associated with user identification 505 under particular circumstances, such as when the consumer is in a particular location or when the consumer is before advertising space on a particular date or time. Again, other possibilities and uses of the data within transaction information 500 should be obvious.

In further embodiments, advertiser 400 may maintain its own records regarding a consumer associated with user identification 505. For example, transaction information 500 can be transmitted to auction environment 430 and user identification 505 can be extracted therefrom by advertiser 440 (or marketing aggregator 460). In such embodiments, advertiser 440 (or marketing aggregator 460) can then cross-reference its own records using user identification 505 to determine if advertiser 440 (or marketing aggregator 460) is in possession of additional information regarding that particular consumer that could help advertiser 440 (or marketing aggregator 460) determine whether to place a bid at auction and, if so, for how much.

Alternatively or additionally, transaction information 500 itself may contain additional information related to a consumer associated with user identification 505. In one embodiment, transaction information 500 may further comprise historical data 550. Historical data 550 may comprise data pertaining to the consumer and/or the consumer's past behavior. For example, historical data 550 may comprise a purchase history for the consumer. In such an embodiment, historical data 550 may comprise a location identification, a purchase item category, a purchase item identification number, a purchase price, a date, and a time. In other embodiments, historical data 550 can comprise more or less data, and may comprise any suitable data that a party to the transaction might find valuable or useful.

Historical data 550 can comprise data dating back some predetermined time period. For example, historical data 550 may comprise data pertaining to a consumer's purchase history dating back a week, a month, or a year. Alternatively, historical data 550 may comprise data pertaining to a consumer's purchase history dating back a shorter or longer period of time.

In use, the historical data can be analyzed by advertiser 440 (or marketing aggregator 460) and used to determine whether to place a bid at auction for advertising space before the consumer and, if so, how much to bid for the advertising space. Advertiser 440 may place more value on a consumer often located in an area in which advertiser 440 conducts business or on a consumer who has purchased goods in the past that are similar or the same as those sold by advertiser 440. Advertiser 440 may also be able to predict, based at least in part on historical data, that when the consumer purchases goods similar or the same as those sold by advertiser 440, the consumer does so at particular locations, or on particular dates, or at particular times. In this manner, advertiser 440 can evaluate historical data 550 and predict whether the consumer may be receptive to an advertisement for a product of advertiser 440 at the advertising space up for auction. In such cases, advertiser 440 may be willing to pay more to place an advertisement at the advertising space than advertiser typically would for other consumers.

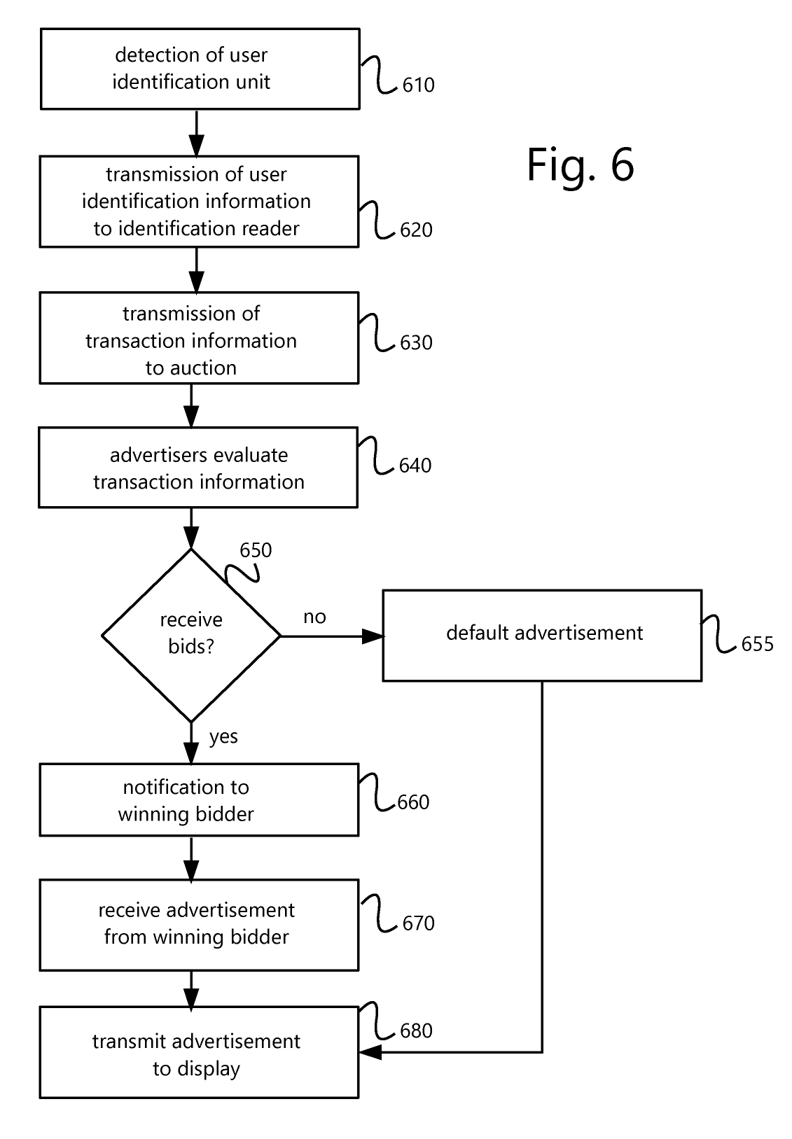

FIG. 6 depicts an exemplary embodiment of a method for placing an advertisement before a consumer. At step 610, a consumer is detected in proximity to an advertising space. This detection can be performed in accordance with any method described above. In one embodiment, the consumer may be carrying or wearing user identification unit 110. In another embodiment, the consumer may be riding in a vehicle equipped with user identification unit 110. In alternative embodiments, user identification unit 110 can be transported in any manner such that the location of the identification unit may be indicative of the location of the consumer associated with the identification unit. Further, regardless of the medium carrying the user identification unit, the unit may be configured to store information including information regarding the consumer as described above.

In another aspect, the presence of user identification unit 110 can be detected by identification unit reader 120. This detection can be performed in a number of ways. For example, where user identification unit 110 and identification unit reader 120 are an RFID tag and RFID reader, respectively, identification unit reader 120 may be configured to broadcast an RF signal that awakens user identification unit 110 when user identification unit 110 comes in proximity to identification unit reader 120. In other embodiments, user identification unit 110 and identification unit reader 120 can be any controller- or processor-based devices configured to detect and communicate with one another. Further, user identification unit 110 and identification unit reader 120 may communicate over any suitable communication channel, including one or more of a near-field, Bluetooth, Internet, network, and wi-fi communication channel. In further embodiments, user identification unit 110 and identification unit reader 120 can communicate over some other wireless communication channel or a wired communication channel.

At step 620, user identification unit 110 can transmit information to identification unit reader 120. The information transmitted to identification unit reader 120 may comprise some or all of the information described above with respect to transaction information 500, or other suitable data. For example, the information transmitted by user identification unit 110 may comprise a user identification number.

Based at least in part on the user identification number, identification unit reader 120 may cross reference a database such as database 140 where additional data related to the consumer associated with user identification unit 110 may be maintained. Alternatively, identification unit reader 120 may route the user identification number to another controller- or processor-based device or system that can access additional data related to the consumer associated with user identification unit 110 from database 140. In further embodiments, the information transmitted by user identification unit 110 may contain additional information rendering the cross referencing of a database for additional information optional or unnecessary.

At step 630, identification unit reader 120 or some other controller- or processor-based device or system receives or retrieves all information from user identification unit 110 and other sources that is to be transmitted to auction environment 430 and creates transaction information 500. As discussed previously, transaction information 500 may be transmitted in the form of a recognized or predetermined protocol or sequence such that one or more parties privy to auction environment 430 can make use of the transaction information. Transaction information 500 may also be transmitted in accordance with a standard upon which all parties privy to auction environment 430 have adopted.

Any advertisers 440 or marketing aggregators 460 privy to auction environment 430 can then evaluate transaction information 500 within the auction environment. Each advertiser 440 or marketing aggregator 460 may evaluate the same or different data from transaction information 500 depending on their own algorithms and the information on which they choose to base their own evaluations. For example, some advertisers may only evaluate a user identification within transaction information and decide to place a bid based, at least in part, on the identification of the consumer in proximity to the advertising space. Other advertisers may take an alternative approach and evaluate other information within transaction information 500. Still other advertisers may consider all or some portion of transaction information 500 when deciding whether to place a bid in auction environment 430. Moreover, as discussed above, one or more advertisers participating in auction environment 430 may use all or a portion of transaction information 500 to cross reference another database or information source in order to compile additional information related to the present auction. Such additional information may pertain to the location of the advertising space, the consumer in proximity to the advertising space, or some other information.

In addition to determining whether to bid on advertising space in a particular auction, one or more advertisers 440 and marketing aggregators 460 may also determine how much to bid within the auction based, at least in part, on transaction information 500. Again, such a decision can be made based on some or all of transaction 500, or in conjunction with additional information gathered from other sources.

At step 650, after the auction is closed, a determination can be made as to whether any bids were received and whether the advertising space is to be awarded to a winning bidder. In one embodiment, if any bids are received then the highest bid can be deemed the winning bidder. In other embodiments, it may first be determined whether any bids met or exceeded a reserve price. In such instances, the highest bid over the reserve price can be deemed the winning bidder.

Where no bids are received, or where a reserve price was not met or exceeded, supplier 420 may display a default advertisement at the advertising space at step 655. Alternatively, supplier 420 may have an agreement with one or more advertisers 440 and marketing aggregators 460 to display a predetermined advertisement in the event that no winning bidder is selected. Such advertisements can be displayed in exchange for a predetermined flat fee or in accordance with some other suitable arrangement between the parties.

At step 660, the winning bidder is notified of their winning bid and payment for the advertising space can be scheduled. As discussed above, the payment for the advertising space can be debited from a predetermined financial account, debited from a prepaid account, scheduled for some time in the future, or in accordance with any other suitable arrangement agreed upon by the parties.

Upon receiving the notification, the winning bidder may also select an advertisement for display at the advertising space. The advertisement can be a predetermined advertisement used for all winning bids or the advertisement can be selected based on some or all information contained in transaction information 500. In other words, the winning bidder has an opportunity to select an advertisement that is suited for the particular consumer associated with user identification unit 110.

In one embodiment, the advertisement may be stored in a database within or outside of a network within which advertiser 440 (or marketing aggregator 460) and/or supplier 420 (or advertising space aggregator 450) have access. In other embodiments, the advertisement may be stored in any suitable location.

After the advertisement for display to the consumer is selected, the advertisement can be transmitted to supplier 420 at step 670. As previously discussed, in one embodiment, the advertisement may be read from a database by advertiser 440 or marketing aggregator 460 and transmitted directly or indirectly to supplier 420. In other embodiments, advertiser 440 or marketing aggregator 460 may transmit only an advertisement identifier that supplier 420 or advertising space aggregator 450 can use to cross reference a database containing advertisements and retrieve the advertisement that the winning bidder desires to display to the consumer. In further embodiments, the advertisement to be displayed in instances where a particular advertiser 440 or marketing aggregator 460 wins an auction can be predetermined and there is no need to transmit an advertisement or an advertisement identifier.

In instances where a winning bidder does not select an advertisement for display at the advertising space or does not select an advertisement for display within a predetermined window of time for selection, a predetermined or default advertisement can be selected by supplier 420 for display to the consumer.

At step 680, upon receipt of the advertisement (optionally using an advertisement identifier), the advertisement is transmitted to display 130. In one embodiment, the advertisement is transmitted to display 130 via one or more of supplier 420, auction environment 150, and identification unit reader 120. In other embodiments, the advertisement is transmitted to display 130 directly from advertiser 440 or marketing aggregator 460. In further embodiments, the advertisement is transmitted to display 130 via some other channel and/or routed through one or more suitable controller- or processor-based device or systems.

As discussed above, the timing for transmission of transaction information 500 to auction environment 430, how long an auction remains open and receptive to bids, when an advertisement is transmitted to display 130, when an advertisement is displayed at display 130, and other events can be determined based, at least in part, on the context of the advertising space, how the consumer's presence was detected, and other factors and information.

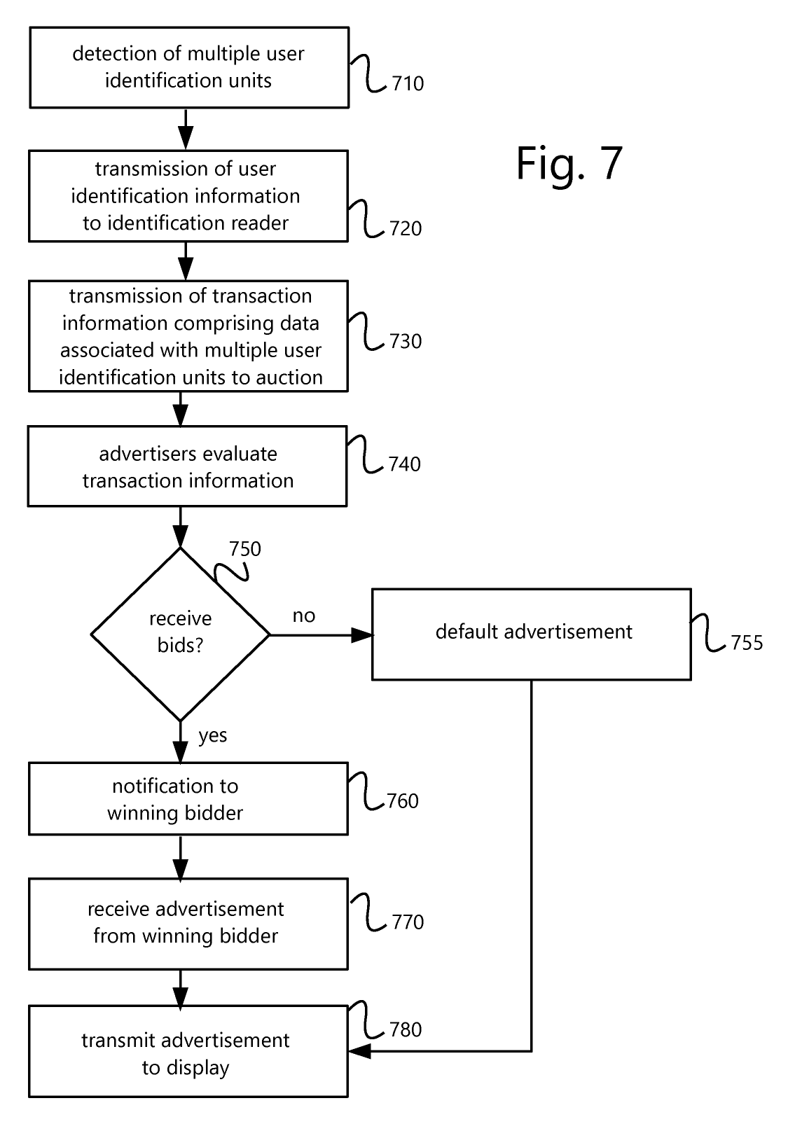

FIG. 7 depicts another exemplary embodiment of a method for placing an advertisement before a consumer. The method depicted in FIG. 7 is substantially similar to the method depicted in FIG. 6 in many respects, however at step 710, rather than identification unit reader 120 detecting the presence of one user identification unit 110 associated with a single consumer, identification unit reader 120 may detect the presence of a plurality of user identification units 110 corresponding to a plurality of consumers.

In one aspect, the detection, reception, and transmission of information from each of the respective user identification units 110 and/or identification unit reader 120 at steps 710 and 720 is substantially similar to that described with respect to steps 610 and 620 in FIG. 6. At step 730, however, the information received or retrieved from all the user identification units 110 and all other sources (as described above) that comprise transaction information 500 can be transmitted to auction environment 430. For example, where three user identification units 110 are detected, indicating the presence of three consumers in proximity to the advertising space, transaction information 500 may comprise information associated with each of the three consumers.

Any advertisers 440 or marketing aggregators 460 privy to auction environment 430 can then evaluate the transaction information 500 within the auction environment at step 740, and as described above with respect to step 640. Such a system can maximize the potential return for supplier 420 and allow advertisers 440 freedom to target individual consumers or groups. For example, advertiser 440 may value placing an advertisement specifically targeted at the second consumer of the group higher than placing an advertisement targeting the group as a whole to the group. In such an instance, transaction information 500 may indicate that only one of the consumers in the group has purchased goods sold by advertiser 440 in the past. As a result, advertiser 440 may not wish to consider attributes of the remaining consumers in the group when determining: whether to bid for the advertising space; how much to bid for the advertising space; and/or what advertisement to select for display. Rather, advertiser 440 may elect to consider only the attributes of the consumer who has purchased goods in the past and base its decision to bid, its bid amount, and its selection of an advertisement for display on those attributes.

Alternatively, another advertiser may find little value in any one of the group members individually, but more value in presenting an advertisement to the group as a whole. For example, an advertiser 440 may be in the business of selling a household product that almost every household needs, but buys fairly infrequently. In such a situation, the advertiser may not place a high bid in instances where only one consumer is likely to see the advertising space up for auction, but may place a significantly higher bid where the advertising space up for auction can be seen by multiple consumers.

In practice, an advertiser can implement any type of suitable aggregation technique to analyze and evaluate transaction information 500 comprising attributes for multiple consumers.

Regardless of whether an advertiser 440 is interested in advertising to a single consumer in the group, the group as a whole, or a subset of the group, all bids can be entered in auction environment 430. Moreover, the value each advertiser 440 or marketing aggregator 460 places on the advertising space at the time the advertising space can be viewed by the group can be reflected in the submitted bids.

After the auction is closed, steps 750-780 can then proceed in substantial accordance with steps 650-680 described above with respect to FIG. 6 until an advertisement is displayed to the group at display 130.

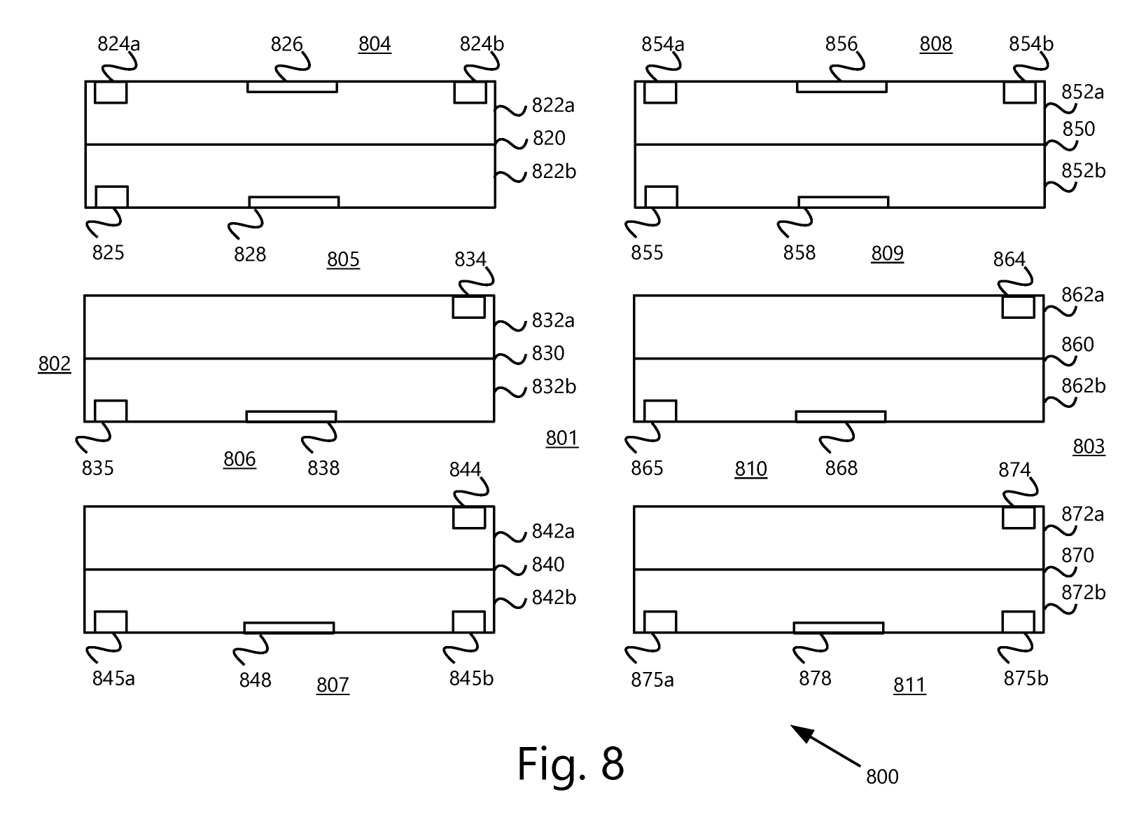

FIG. 8 depicts an exemplary embodiment of a system as described herein. In one aspect, the system can be implemented in a store setting 800. Store setting 800 can be any number of indoor or outdoor store selling one or more goods to consumers. For example, store setting 800 could be a grocery store, a gas station, a clothing store, a mall, or some other suitable commercial setting. Of course, this list is only exemplary and not intended to be exhaustive. Alternative settings in which the system described herein can be implemented should be obvious.

In another aspect, setting 800 can comprise a plurality of shelving units. In the embodiment depicted in FIG. 8, setting 800 may comprise shelving units 820, 830, 840, 850, 860, and 870. Further, each shelving unit may comprise a pair of oppositely facing shelves such that goods can be displayed to consumers on both sides of the shelving units. In particular, shelving unit 820 may comprise opposing shelves 822a and 822b, shelving unit 830 may comprise opposing shelves 832a and 832b, shelving unit 840 may comprise opposing shelves 842a and 842b, shelving unit 850 may comprise opposing shelves 852a and 852b, shelving unit 860 may comprise opposing shelves 862a and 862b, and shelving unit 870 may comprise opposing shelves 872a and 872b. In alternative embodiments, shelving units can be any structure configured to display products for sale, can be one- or two-sided, and need not assume the structure depicted in FIG. 8.

In another aspect, the shelving units are arranged in a 3×2 matrix that define a center aisle 801, opposing peripheral aisles 802 and 803, and lateral aisles 804-811. It should be obvious that alternative embodiments are possible in which the shelving units are arranged in other suitable configurations defining different aisle configurations. In further embodiments, the shelving units can be arranged only around the perimeter of setting 800 surrounding a central space and defining no aisles. Other configurations are also possible and within the scope of this disclosure.

Each shelving unit may comprise one or more identification unit readers and/or one or more displays. In the embodiment depicted in FIG. 8, shelving unit 820 can comprise identification unit readers 824a, 824b, and 825, and displays 826 and 828. Shelving unit 830 can comprise identification unit readers 834 and 835, and display 838. Shelving unit 840 can comprise identification unit readers 844, 845a, and 845b, and display 848. Shelving unit 850 can comprise identification unit readers 854a, 854b, and 855, and displays 856 and 858. Shelving unit 860 can comprise identification unit readers 864 and 865, and display 868. Shelving unit 870 can comprise identification unit readers 874, 875a, and 875b, and display 878.

In this manner, each of lateral aisles 804-811 may be equipped with at least one display and an identification unit reader at each end. For example, a consumer on end aisle 804 is likely to view display 826 and can be detected by one or both of identification unit readers 824a and 824b of shelving unit 820. A consumer on a middle aisle 805, on the other hand, is likely to view display 828 of shelving unit 820 and can be detected by one or both of identification unit reader 825 of shelving unit 820 and identification unit reader 834 of shelving unit 830. In this manner, there is no need for every shelf of each shelving unit to comprise an identification unit reader. Rather, one identification unit reader of one shelving unit can coordinate with an identification unit reader of another shelving unit in order to determine when a consumer enters or exits an aisle. Further, while the depicted embodiment comprises one display on each aisle, other embodiments are possible wherein more than one display or no displays are present in one or more aisles. Additionally, while the depicted identification unit readers are positioned proximate to the end of each shelving unit, in other embodiments the identification unit readers can be located elsewhere with respect to the shelving units, or they the shelving units may comprise additional identification unit readers in other locations. For example, one or more shelving units may comprise additional identification unit readers proximate the respective displays in order to confirm when a consumer is in a line of sight of the respective display. In still further embodiments, one or more identification unit readers can be incorporated into a display. Moreover, while the shelving units shown in FIG. 8 comprise the identification unit readers and the displays, other embodiments are possible wherein one or more of the identification unit readers and displays are not incorporated into a shelving unit. For example, one or more identification unit readers and/or displays can be incorporated into other structures, or they may be independent structures.

Additional identification unit readers can also be located at the end caps of each shelving unit in order to detect the presence of a consumer on one of peripheral aisles 802, 803, or center aisle 801. Alternatively, identification unit readers 824a, 825, 835, and 845a can also detect the presence of a consumer on peripheral aisle 802. Likewise, identification unit readers 824b, 834, 844, 845b, 854a, 855, 865, and 875a can detect the presence of a consumer in center aisle 801, and identification unit readers 854b, 864, 874, and 875b can detect the presence of a consumer in peripheral aisle 803.

The number and placement of the shelving units, aisles, unit identification readers, and displays are only exemplary. Alternative configurations and positions for the various components should be obvious in light of this disclosure.

In use, when a consumer with a user identification unit 110 on his or her person enters an aisle, user identification unit 110 (and therefore, the consumer's presence) can be detected and the advertising space at the respective display can be transmitted to auction environment 430 where advertisers 440 and/or marketing aggregator 460 can submit bids for the advertising space. The winning bidder may then be afforded the opportunity to select and transmit an advertisement for display to the consumer while the consumer is shopping in the aisle.

For example, a consumer with a user identification unit 110 enters aisle 810 from center aisle 801, the consumer's presence can be detected by identification unit reader 865. Upon detection, supplier 420 can make the advertising space at display 868 available for purchase through auction environment 430. The timing of when the advertising space may be made available within auction environment 430, how long the auction remains open for bids, when the advertisement of the winning bidder is displayed at display 868, and how long the advertisement is displayed at display 868 may be tailored according to supplier 430 or some other party's preferences and/or may be dictated by circumstances. Various possibilities regarding the timing of events are described above.

In one embodiment, the advertising space at display 868 is made available within auction environment 430 immediately upon detection of the consumer by identification unit reader 865. The auction may then close to further bidding when the consumer is detected within a line of sight of display 868, for example by another identification unit reader located further down aisle 810. After the consumer is detected within a line of sight of display 868, the auction may be closed, a winning bidder determined and notified, an advertisement received, and the advertisement may be displayed at display 868 for viewing by the consumer. The advertisement may also remain on display 868 until the consumer is detected leaving aisle 810 by identification unit reader 865 or 874, or is detected outside a line of sight of display 868 by one or more other identification unit readers on aisle 810.

In this manner, an advertiser 440 or marketing aggregator 460 can specifically target a consumer, displaying an advertisement tailored to that consumer in light of information gathered regarding the consumer and his or her purchase habits, in conjunction with location information regarding that consumer. For instance, where a consumer with a history of purchasing a particular type of cereal is detected on an aisle where cereal is displayed and sold, the advertiser marketing the consumer's usual cereal or a competitor of the consumer's usual cereal may find the nearby advertising space valuable. On the other hand, where the consumer enters an aisle on which he or she has never purchased an item, the advertising space at the respective display may not be considered as valuable.

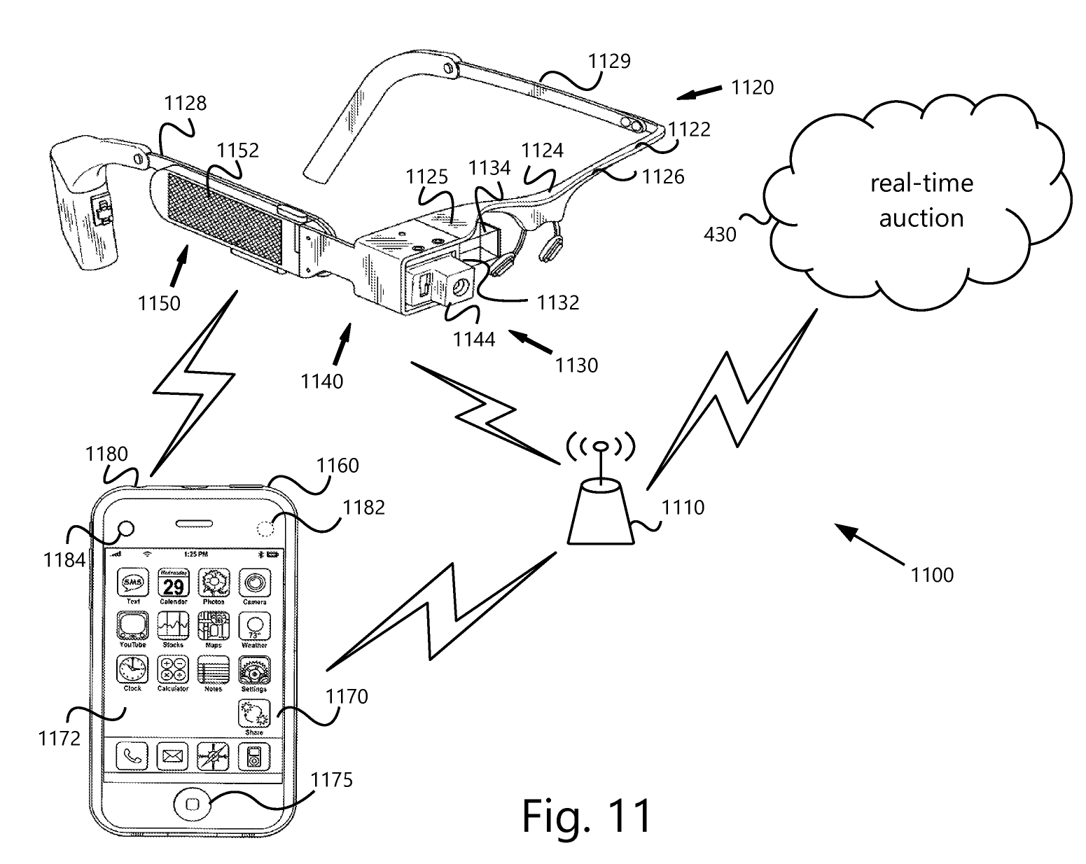

In a further embodiment, where a consumer is wearing a head-mounted display, advertisements may be displayed to that consumer in an augmented reality environment somewhere within the consumer's field of view. In such an embodiment, the head-mounted display may comprise one or more of user identification unit 110, identification unit reader 865 and display 868. For example, after an advertisement has been transmitted by a winning bidder, the advertisement can be displayed in the upper right-hand corner of the consumer's field of view as the consumer walks along aisle 810. In particular, the advertisement can be displayed in a fixed location with respect to the consumer's field of view, or it can be displayed superimposed over a physical object such that the position of the advertisement within the consumer's field of view changes as the consumer moves relative to the physical object. Additional details and embodiments related to head-mounted displays and augmented reality environments are discussed below with respect to FIG. 11.

In still further embodiments, in addition to an advertisement being displayed to one or more consumers at display 868, ancillary information associated with the advertisement may also be transmitted to the consumer(s). For example, where user identification unit 110 is incorporated into a smart phone, cell phone, tablet, laptop, or another controller- or processor-based device, ancillary information associated with the advertisement may be received at user identification unit 110 before, during, or after the time at which the advertisement is displayed at display 868. In such an instance, one or more consumers may be within a line of sight of an advertisement displayed at display 868 while ancillary information such as the advertiser's contact information, the advertiser's store location, or a coupon for goods sold by the advertiser is transmitted to user identification unit 110 and/or displayed on an ancillary display incorporated into the consumers' smart phone or other controller- or processor-based device. Additionally, the consumer may be afforded an opportunity to interact with the ancillary information. For example, the consumer may be afforded an opportunity to store one or more portions of the ancillary information at user identification unit 110 or an associated controller- or processor-based device for subsequent retrieval. For example, after a coupon for goods sold by the advertiser is transmitted and displayed at the ancillary display, the consumer may be afforded an opportunity to store the coupon for later retrieval when the consumer checks out of the store or when the consumer checks out during a subsequent visit to the store. In this manner, even in cases where an advertisement is displayed at display 868 for viewing by more than one consumers, ancillary information associated with the advertisement or the advertiser can be transmitted to one or more consumers in the group for display at each consumer's ancillary display and the ancillary information may be more specifically tailored to each consumer on an individual basis or tailored to a subset of the group. Of course, other possibilities for ancillary information, ancillary display, ancillary display device, and consumer inputs and commands are also possible and should be obvious in light of this disclosure.

When the consumer finishes shopping and checks out, the consumer may present his or her user identification unit to a cashier. The user identification unit, in some embodiments, may comprise a shoppers' discount card used to attain discounts on goods. In other embodiments, the user identification unit may comprise some other card, object, or device. In this manner, all purchases made by the consumer can be recorded and associated with the consumer's identification number in one or more databases, as discussed above. Thus, when the consumer returns to the store in the future, the goods purchased during the present store visit will be detailed in transaction information 500 and made available to those buying or selling advertising space in proximity to the consumer during the future visit. Further, where the consumer has stored ancillary information associated with the advertisements viewed while in the store and comprising one or more coupons at user identification unit 110, those coupons may be retrieved during checkout and applied to the consumer's purchase.

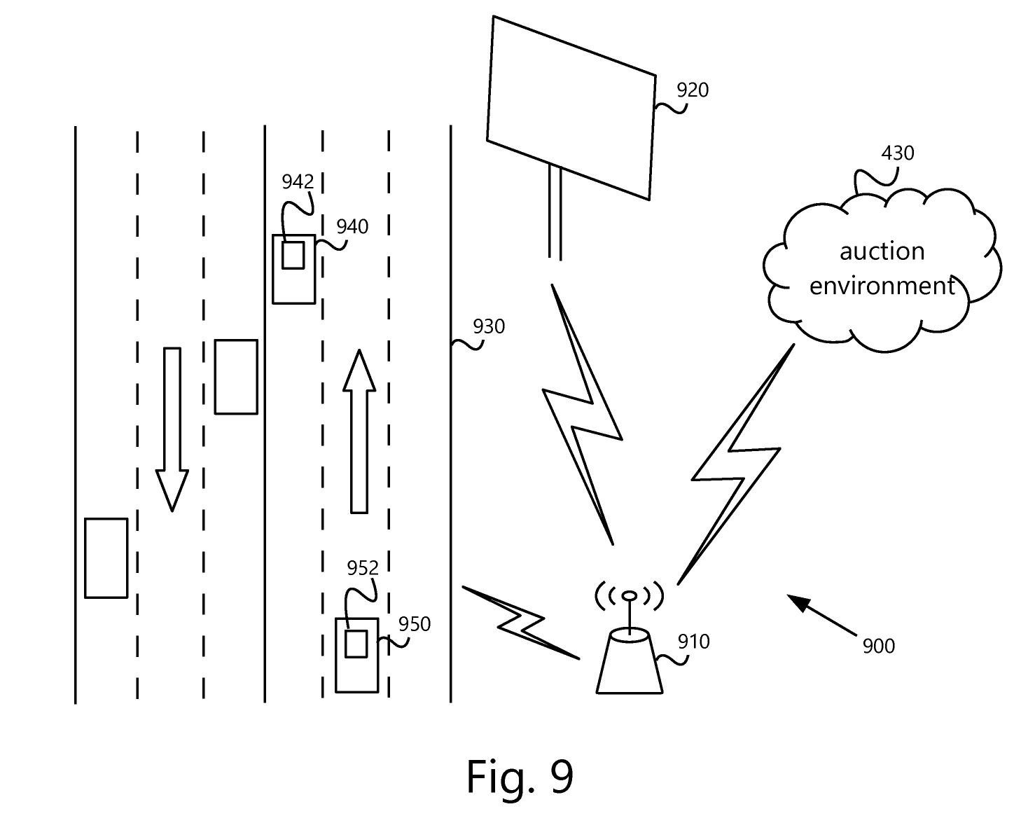

FIG. 9 depicts another exemplary embodiment of a system as described herein. In one aspect, the system can be implemented in a roadside or automotive setting 900. For example, system 900 can be implemented along a road or highway. Alternatively, system 900 can be implemented along pedestrian pathways such as sidewalks, common areas of shopping malls, walking trails, and bike paths. Of course, this list is only exemplary and not intended to be exhaustive. Alternative settings in which system 900 can be implemented should be obvious.

In another aspect, system 900 may comprise an identification unit reader 910 and a display 920 proximate to a road 930. In particular, identification unit reader 910 and/or display 920 may be in communication with auction environment 430, as described above. Further, while identification unit reader 910 and display 920 are depicted as distinct objects, in other embodiments they may be incorporated into a single object or device. Moreover, though only one identification unit reader 910 and one display 920 are depicted in FIG. 9, other embodiments may comprise a plurality of identification unit readers and/or displays.

In use, a consumer driving along road 930 in a car may be detected by identification unit reader 910. In one embodiment, the consumer's vehicle 940 may comprise a user identification unit 942 configured to communicate with identification unit reader 910. For example, the vehicle may be equipped with a GPS unit or some other controller- or processor-based device configured to communicate with identification unit reader 910. In other embodiments, the consumer may be traveling with a cellular phone, smart phone, tablet, laptop, or some other controller- or processor-based device configured to communicate with identification unit reader 910.

As vehicle 940 and user identification unit 942 come in proximity to identification unit reader 910, a handshake may occur enabling user identification unit 942 to transmit information to identification unit reader 910. Numerous methods and communication channels are suitable to facilitate this exchange of information, and several methods and channels are discussed above. Additionally, any type of suitable information may be transmitted between user identification unit 942 and identification unit reader 910. Examples of information that can be transmitted between the two devices are described above.

Once the consumer's presence is detected by identification unit reader 910, the advertising space at display 920 may be made available for purchase through auction environment 430. The timing of when the advertising space may be made available within auction environment 430, how long the auction remains open for bids, when the advertisement of the winning bidder is displayed at display 920, and how long the advertisement is displayed at display 920 may be tailored according to the supplier 430 of the advertising space or some other party's preferences and/or may be dictated by circumstances. Various possibilities regarding the timing of events are described above.

In one embodiment, the advertising space at display 920 is made available within auction environment 430 immediately upon detection of the consumer by identification unit reader 910. The auction may then close to further bidding when the consumer is detected within a line of sight of display 920, for example by another identification unit reader located closer to display 920 along road 930. After the consumer is detected within a line of sight of display 920, the auction may be closed, a winning bidder determined and notified, an advertisement received, and the advertisement may be displayed at display 920 for viewing by the consumer as he or she travels past the display. The advertisement may also remain on display 920 until, for example, the consumer is detected outside a line of sight of display 920 by one or more other identification unit readers located further along road 930.

In this manner, an advertiser 440 or marketing aggregator 460 can specifically target a consumer, displaying an advertisement tailored to that consumer in light of information gathered regarding the consumer and his or her purchase habits, in conjunction with location information regarding that consumer. For instance, where user identification unit 942 is incorporated into a vehicle, information such as the vehicle make and model, areas in which the consumer typically travels, and events the consumer typically attends can be stored and incorporated into transaction information 500 supplied to advertisers 440 and/or marketing aggregators 460. Of course, other information can also be stored and incorporated into transaction information 500 and the above examples should not be considered exhaustive. Further, where user identification unit 942 is incorporated into a smart phone or other portable, personal device, other or additional information may be stored, transmitted, and/or incorporated into transaction information 500. Thus, in one example, where a consumer with a history of attending sporting events is detected, an advertiser marketing the nearby sports team or sports television channel may find advertising space at display 920 valuable for the period of time in which the consumer is within a line of sight of display 920. On the other hand, the advertising space at display 920 may be less valuable to an advertiser marketing household goods where the consumer has no history of purchasing such goods.

In another embodiment, where more than one vehicle equipped with or carrying a user identification unit is detected, information from a portion or all of the detected user identification units can be incorporated into transaction information 500. For example, where vehicle 940 and vehicle 950 are traveling along road 930 in such a manner that the period of time in which each is within a line of sight of display 920 substantially overlaps, information received and gathered for each respective consumer may be transmitted to auction environment 430.

Within auction environment 430, advertisers 440 and/or marketing aggregators 460 can evaluate the information and decide whether to target one of vehicles 940 and 950 with an advertisement, or aggregate the consumer data of the group and target the group as a whole with an advertisement at display 920. FIG. 9 depicts vehicles 940 and 950, however, it should be obvious that the same principals apply regardless of how many consumers and vehicles are detected in proximity to display 920 and identification unit reader 910. Ultimately, advertisers 440 and/or marketing aggregators 460 are given freedom to display advertisements to any one or more of the consumers within a group, and submit bid prices at auction environment 430 commensurate with the value they place on advertising space at display 920 at the time the one or more consumers may be viewing display 920.

As depicted in FIG. 9, display 920 comprises a stationary billboard along road 930. In other embodiments, however, display 920 can be any display configured to receive and display advertisements to consumers traveling along road 930. In further embodiments, display 920 may be located inside a consumer's vehicle. For example, display 920 may be incorporated into the navigation screen of vehicle 940, or display 920 may be incorporated into the display on the consumer's cell phone, smart phone, tablet, or laptop. In such embodiments, no aggregation of consumer group data may be necessary as advertisers can display advertisement within a consumer's vehicle that are only viewable by the consumer. Alternatively, where multiple consumers are detected within a vehicle, advertisers and/or marketing aggregators may again decide whether to display an advertisement targeting one or more of the vehicle occupants or an advertisement targeting the group as a whole.

In a further embodiment, where a consumer in vehicle 940 is wearing a head-mounted display, advertisements may be displayed to that consumer in an augmented reality environment somewhere within the consumer's field of view. In such an embodiment, the head-mounted display may comprise one or more of user identification unit 942, identification unit reader 910, and display 920. For example, after an advertisement has been transmitted by a winning bidder, the advertisement can be displayed in the upper right-hand corner of the consumer's field of view where a billboard display 920 would normally appear relative to the consumer as he or she travels down road 930, however the physical presence of a billboard would be unnecessary. Alternatively, the advertisement can be displayed in any fixed location with respect to the consumer's field of view, or it can be displayed superimposed over a physical object (such as a billboard) such that the position of the advertisement within the consumer's field of view changes as the consumer moves relative to the physical object. Additional details and embodiments related to head-mounted displays and augmented reality environments are discussed below with respect to FIG. 11.

In still further embodiments, in addition to an advertisement being displayed to one or more consumers at display 920, ancillary information associated with the advertisement may also be transmitted to the consumer(s). For example, where user identification unit 942 is incorporated into a vehicle, smart phone, cell phone, tablet, laptop, or another controller- or processor-based device, ancillary information associated with the advertisement may be received at user identification unit 942 before, during, or after the time at which the advertisement is displayed at display 920. In such an instance, one or more consumers may be within a line of sight of an advertisement displayed at display 920 while ancillary information such as the advertiser's contact information, the advertiser's store location, or a coupon for goods sold by the advertiser is transmitted to user identification unit 942 and/or displayed on an ancillary display incorporated into the consumers' vehicle, smart phone or other controller- or processor-based device. Additionally, the consumer may be afforded an opportunity to interact with the ancillary information. For example, the consumer may be afforded an opportunity to store one or more portions of the ancillary information at user identification unit 942 or an associated controller- or processor-based device for subsequent retrieval. For example, after a coupon for goods sold by the advertiser is transmitted and displayed at the ancillary display, the consumer may be afforded an opportunity to store the coupon for later retrieval when the consumer visits the advertiser's store or website. In this manner, even in cases where an advertisement is displayed at display 920 for viewing by more than one consumers, ancillary information associated with the advertisement or the advertiser can be transmitted to one or more consumers in the group for display at each consumer's ancillary display and the ancillary information may be more specifically tailored to each consumer on an individual basis or tailored to a subset of the group. Of course, other possibilities for ancillary information, ancillary display, ancillary display device, and consumer inputs and commands are also possible and should be obvious in light of this disclosure.

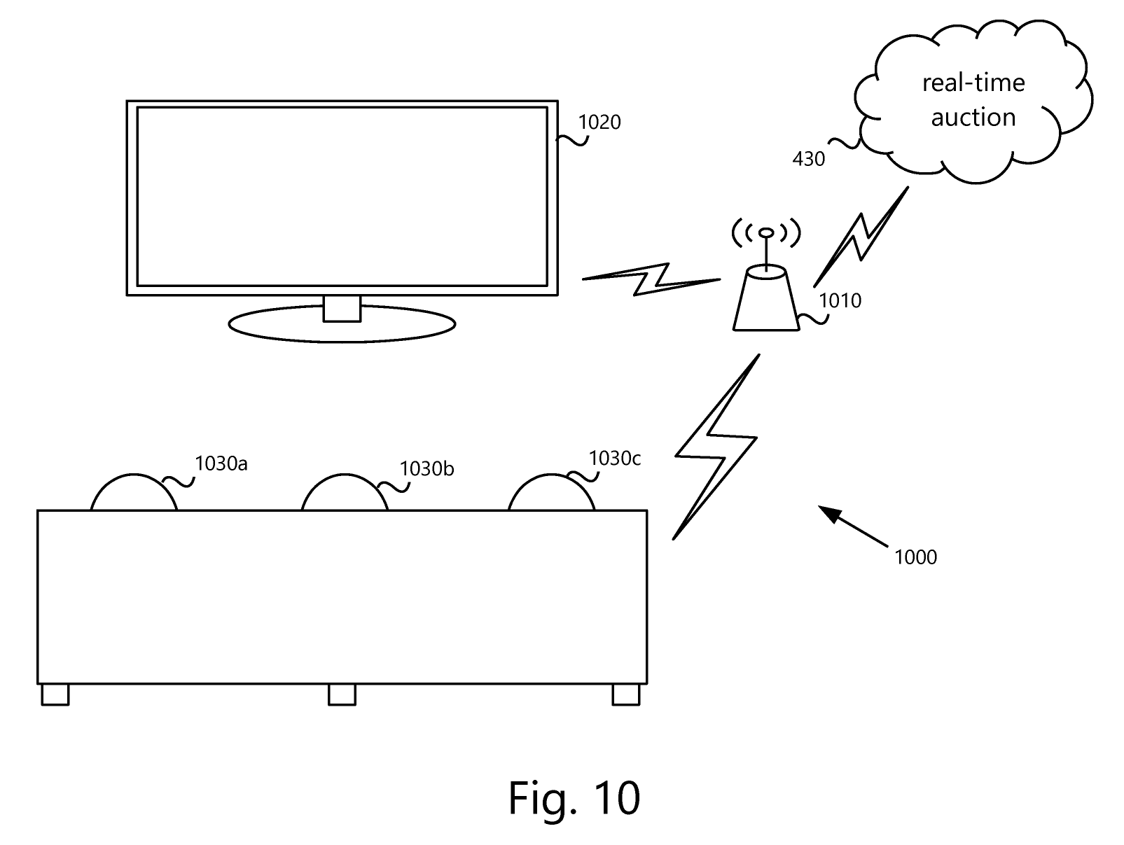

FIG. 10 depicts another exemplary embodiment of a system as described herein. In one aspect, the system can be implemented in a video entertainment setting 1000. For example, system 1000 can be implemented in a consumer's living room or den. Alternatively, system 1000 can be implemented in a movie theater or a live performance or event. Of course, these examples are only exemplary and not intended to be exhaustive. Alternative settings in which system 1000 can be implemented should be obvious.

In another aspect, system 1000 may comprise an identification unit reader 1010, a display 1020, and one or more user identification units 1030. In particular, identification unit reader 1010 and/or display 1020 may be in communication with auction environment 430, as described above. Further, while identification unit reader 1010 and display 1020 are depicted as distinct objects, in other embodiments they may be incorporated into a single object or device such as a television. Moreover, though only one identification unit reader 1010 and display 1020 is depicted in FIG. 10, other embodiments may comprise a plurality of identification unit readers and/or displays.

In use, a consumer in proximity to display 1020 may be detected by identification unit reader 1010. In one embodiment, the consumer may be carrying or wearing a card, object, or device comprising a user identification unit 1030a configured to communicate with identification unit reader 1010. For example, the consumer may be carrying an RFID tag, cell phone, smart phone, tablet, laptop, or some other controller- or processor-based device configured to communicate with identification unit reader 1010. In alternative embodiments, user identification unit 1030a and identification unit reader 1010 may be incorporated into the same device, such as a cable box, a video game console, or a dvd or blu-ray player. In further embodiments, user identification unit 1030a, identification unit reader 1010, and display 1020 may all be incorporated into a single device, such as a television or a projector.

When the consumer and user identification unit 1030a come in proximity to identification unit reader 1010, a handshake may occur enabling user identification unit 1030a to transmit information to identification unit reader 1010. Numerous methods and communication channels are suitable to facilitate this exchange of information, and several methods and channels are discussed above. Additionally, any type of suitable information may be transmitted between user identification unit 1030a and identification unit reader 1010. Examples of information that can be transmitted between the two devices are described above.

Once the consumer's presence is detected by identification unit reader 1010, the advertising space at display 1020 may be made available for purchase through auction environment 430. The timing of when the advertising space may be made available within auction environment 430, how long the auction remains open for bids, when the advertisement of the winning bidder is displayed at display 1020, and how long the advertisement is displayed at display 1020 may be tailored according to the supplier 430 of the advertising space or some other party's preferences and/or may be dictated by circumstances. Various possibilities regarding the timing of events are described above.

In one embodiment, where display 1020 is displaying a television broadcast, the advertising space at display 1020 is made available within auction environment 430 after the detection of the consumer by identification unit reader 1010, but not until a time relative to a designated commercial break within the broadcast. For example, at commencement of the commercial break or some predetermined time before commencement of the commercial break, the advertising space at display 1020 may be made available within auction environment 430. The auction may then close to further bidding at a time coinciding with commencement of the commercial break or some other predetermined time before commencement of the commercial break. After the auction closes, a winning bidder is determined and notified, and an advertisement is received, the advertisement may be displayed at display 1020 for viewing by the consumer during the commercial break. The advertisement may also remain on display 1020 until, for example, the end of the commercial break or the end of some predetermined segment of the commercial break.

In this manner, an advertiser 440 or marketing aggregator 460 can specifically target a consumer, displaying an advertisement tailored to that consumer in light of information gathered regarding the consumer and his or her purchase habits, in conjunction with location information regarding that consumer. For instance, where user identification unit 1030a is incorporated into a smart phone, tablet, or laptop, information pertaining to the consumer's online purchase history, web traffic, personal calendar, and travel history can be stored and incorporated into transaction information 500 supplied to advertisers 440 and/or marketing aggregators 460. In other examples where user identification unit 1030a is incorporated into a cable box, for example, information regarding the programming the consumer typically views may also be stored and incorporated into transaction information 500. Of course, other information can also be stored and incorporated into transaction information 500 and the above examples should not be considered exhaustive.

Thus, in one example, where a consumer with a history of watching home improvement programming or making online purchases at a home improvement store is detected, an advertiser marketing home improvement supplies may find advertising space at display 1020 valuable for the period of time in which the consumer is within a line of sight of display 1020. On the other hand, the advertising space at display 1020 may be less valuable to an advertiser marketing financial products where the consumer has no history of purchasing such goods and no history of watching programming related to financial products.

In another embodiment, where more than one user identification unit is detected, information from a portion or all of the detected user identification units can be incorporated into transaction information 500. For example, where multiple consumers are positioned in a line of sight of display 1020 and user identification units 1030a, 1030b, and 1030c are detected, information received and gathered for each respective user identification unit may be transmitted to auction environment 430.

Within auction environment 430, advertisers 440 and/or marketing aggregators 460 can evaluate the information and decide whether to target one of the consumers within the group with an advertisement, or aggregate the consumer data of the group and target the group as a whole with an advertisement at display 1020. FIG. 10 depicts three consumers each associated with a respective user identification unit, however, it should be obvious that the same principals apply regardless of how many consumers and user identification units are detected in proximity to display 1020 and identification unit reader 1010. Ultimately, advertisers 440 and/or marketing aggregators 460 are given freedom to display advertisements to any one or more of the consumers within a group, and submit bid prices at auction environment 430 commensurate with the value they place on advertising space at display 1020 at the time the one or more consumers may be viewing display 1020.

As depicted in FIG. 10, display 1020 comprises a television or monitor. In other embodiments, however, display 1020 can be any display configured to receive and display advertisements to consumers in proximity to identification unit reader 1010. For example, display 1020 may be incorporated into the display on the consumer's cell phone, smart phone, tablet, or laptop. In such embodiments, no aggregation of consumer group data may be necessary as advertisers can display advertisements that are only viewable by the consumer. Additionally, advertisers can transmit advertisements to the consumer's cell phone, smart phone, tablet, or laptop at times when it is likely the consumer is receptive to receiving the advertisements, for example, during a commercial break in the programming the consumer is currently watching.

In a further embodiment, where a consumer is wearing a head-mounted display, advertisements may be displayed to that consumer in an augmented reality environment somewhere within the consumer's field of view. In such an embodiment, the head-mounted display may comprise one or more of user identification unit 1030a, identification unit reader 1010, and display 1020. For example, after an advertisement has been transmitted by a winning bidder, the advertisement can be displayed in the upper right-hand corner of the consumer's field of view. Alternatively, the advertisement can be displayed in any fixed location with respect to the consumer's field of view, or it can be displayed superimposed over a physical object (such as a television screen) such that the position of the advertisement within the consumer's field of view changes as the consumer moves relative to the physical object. Additional details and embodiments related to head-mounted displays and augmented reality environments are discussed below with respect to FIG. 11.

In still further embodiments, in addition to an advertisement being displayed to one or more consumers at display 1020, ancillary information associated with the advertisement may also be transmitted to the consumer(s). For example, where user identification unit 1030a is incorporated into a smart phone, cell phone, tablet, laptop, or another controller- or processor-based device, ancillary information associated with the advertisement may be received at user identification unit 1030a before, during, or after the time at which the advertisement is displayed at display 1020. In such an instance, one or more consumers may be within a line of sight of an advertisement displayed at display 1020 while ancillary information such as the advertiser's contact information, the advertiser's store location, or a coupon for goods sold by the advertiser is transmitted to user identification unit 1030a and/or displayed on an ancillary display incorporated into the consumers' smart phone or other controller- or processor-based device. Additionally, the consumer may be afforded an opportunity to interact with the ancillary information. For example, the consumer may be afforded an opportunity to store one or more portions of the ancillary information at user identification unit 1030a or an associated controller- or processor-based device for subsequent retrieval. For example, after a coupon for goods sold by the advertiser is transmitted and displayed at the ancillary display, the consumer may be afforded an opportunity to store the coupon for later retrieval when the consumer visits the advertiser's store or website. In this manner, even in cases where an advertisement is displayed at display 1020 for viewing by more than one consumers, ancillary information associated with the advertisement or the advertiser can be transmitted to one or more consumers in the group for display at each consumer's ancillary display and the ancillary information may be more specifically tailored to each consumer on an individual basis or tailored to a subset of the group. Of course, other possibilities for ancillary information, ancillary display, ancillary display device, and consumer inputs and commands are also possible and should be obvious in light of this disclosure.

FIG. 11 depicts another exemplary embodiment of a system as described herein. In one aspect, system 1100 may comprise an identification unit reader 1110 and a head-mounted display device 1120. Alternatively, system 1100 may comprise identification unit reader 1110 and a communication device 1160. In other embodiments, system 1110 may comprise identification unit reader 1110, head-mounted display device 1120, and communication device 1160. In further embodiments, head-mounted display device 1120 and communication device 1160 may be incorporated into a single device. Moreover, though only one identification unit reader 1110, head-mounted display device 1020, and communication device 1160 are depicted in FIG. 11, other embodiments may comprise a plurality of one or more of the depicted components.

Head-mounted display device 1120 can comprise a frame 1122, a display 1130, a receiver 1140, and an input device 1150. In one aspect, frame 1122 can comprise a bridge portion 1124, opposing brow portions 1125, 1126, and opposing arms 1128, 1129. In use, frame 1122 is configured to support head-mounted display device 1120 on a user's head or face.

Display 1130, receiver 1140, and input device 1150 can each be mounted to frame 1122. In one embodiment, display 1130 and receiver 1140 can be mounted at one end of brow portion 1125. In alternative embodiments, display 1130 and receiver 1140 can be mounted at some other portion of frame 1122 and/or at different portions of frame 1122. As depicted in FIG. 11, head-mounted display device 1120 can comprise a single display 1130. In other embodiments, head-mounted display device 1120 can comprise a pair of displays 1130, one located proximate to each of the user's eyes.

Receiver 1140 can comprise an on-board computing system 1142 (not shown) and a video camera 1144. In one aspect, on-board computing system 1142 can be wire- or wirelessly-connected to other components of display device 1120, such as display 1130, input device 1150, and camera 1144. In another aspect, on-board computing system 1142 can comprise a processor and memory, and may be configured to send, receive, and analyze data to and from other components of head-mounted display device 1120. On-board computing system 1142 may be further configured to send, receive, and analyze data to and from other devices, for example, communication device 1160 and/or identification unit reader 1110. An exemplary embodiment of on-board computing system 1142 is described above with respect to FIG. 2.

Video camera 1144 can be positioned on brow portion 1125 or arm 1128 of frame 1122. In other embodiments, video camera 1144 can be positioned elsewhere on frame 1122. In one aspect, video camera 1144 can be any suitable camera configured to capture still images and video at one or more resolutions and/or frame rates. In another aspect, video camera 1144 is a forward facing camera so as to capture images and video representative of what a user is seeing or facing. Further, video camera 1144 can be in communication with receiver 1140 and on-board computing system 1142 such that images or video captured by camera 1144 can be transmitted to receiver 1140. Likewise, information can also be transmitted to camera 1144 from receiver 1140.

In the embodiment depicted in FIG. 11, head-mounted display device 1120 comprises a single, front-facing camera 1144. In alternative embodiments, display device 1120 may comprise multiple cameras 1144, one or more of which may be rear-facing so as to capture still images or video of the user's face or subjects located behind the user. For example, head-mounted display device 1120 may comprise a rear-facing camera directed substantially at the location of a user's eye such that the camera can detect the general direction in which the user is looking or whether the user's eye is in an open or closed state. This information can then be transmitted to receiver 1140 for use in applications where information about the user's eye direction or eye state may be desirable.

In another aspect, display 1130 can comprise a projector 1132 and a viewing prism 1134, as well as other electronic components. In one aspect, video and/or images transmitted from on-board computing system 1142 can be received by projector 1132. Projector 1132 can then project the received video or images onto a receiving surface of prism 1134. Prism 1134 can be configured in such a way to reflect the images projected onto the receiving surface onto viewing surface of prism 1134 in such a way that the images are visible to the user by looking into the viewing surface.

In another aspect, prism 1134 can be transparent and, as a result, the appearance of images and/or video on the viewing surface may not block the user's field of vision. In this manner, video or images presented on the viewing surface can afford head-mounted display device 1120 augmented reality functionality, superimposing images and video over the user's field of view.

In one embodiment, projector 1132 can include an image source such as an LCD, CRT, or OLED display, as well as a lens for focusing an image on a desired portion of prism 1134. In other embodiments, projector 1132 can be some other suitable image and/or video projector.

In another aspect, additional electronic components of display 1130 can comprise control circuitry for causing projector 1132 to project desired images or video based on signals received from the on-board computing system 1142. In a further aspect, the control circuitry of display 1130 can cause projector to project desired images or video onto particular portions of the receiving surface of prism 1134 so as to control where a user perceives an image in his or her field of view.

In a further aspect, prism 1134 and projector 1132 can be translationally and rotatably coupled within display 1130. Further, prism 1134 and projector 1132 may be configured to translate and rotate independent of one another and in response to commands received from the control circuitry of display 1130 and/or on-board computing system 1142. In one embodiment, projector 1132 comprises a cylindrical shaft that mates with a cylindrical recess in prism 1134. This configuration enables prism 1134 to rotate with respect to a user's eye and, as a result of altering the angle of the viewing surface with respect to the user's eye, move an image displayed to the user on the viewing surface of prism 1134 up and down within the user's field of view.

In another aspect, prism 1134 and/or projector 1132 can be coupled within display 1130 or to frame 1122 in such a manner so as to allow prism 1134 and/or projector 1132 to translate with respect to frame 1122. In this manner, prism 1134 and/or projector 1132 can translate with respect to frame 1122, and as a result, move an image displayed to the user on the viewing surface of prism 1134 left and right within the user's field of view.

In use, prism 1134 can be positioned such that a user can comfortably perceive the viewing surface. In one embodiment, prism 1134 can be located beneath brow portion 1125 of frame 1122. In other embodiments, prism 1134 can be located elsewhere. For example, prism 1134 can be positioned directly in front of a user's eye. Alternatively, prism 1134 can be positioned above or below the center of the user's eye. Additionally, prism 1134 can be positioned to the left or the right of the center of the user's eye. Moreover, in some embodiments, the position of prism 1134 with respect to frame 1122, and thus, the user's eye can be adjusted so as to change the positional relationship between the user's eye and an image displayed on the viewing surface.

In one embodiment, prism 1134 can be a hexahedron having six faces comprising three pairs of opposing rectangular surfaces. In other embodiments, prism 1134 may exhibit some other shape comprising rectangular and square surfaces. In further embodiments, prism 1134 can exhibit some other shape. Prism 1134 can also be comprised of any suitable material or combination of materials. Regardless of the shape or composition of prism 1134, prism 1134 can be configured such that its receiving surface, located proximate projector 1132, can receive an image from projector 1132 and make that image visible to a user looking into its viewing surface. In some embodiments, the receiving surface is substantially perpendicular to the viewing surface such that a transparent prism can be used to combine the projected image with the user's field of view, and thus, achieve augmented reality functionality. In other embodiments, the receiving surface and the viewing surface may be at some other angle with respect to one another that is greater than or less than ninety degrees. In further embodiments, prism 1134 can be opaque or semi-transparent.

In still further embodiments, display 1130 may comprise a substantially flat lens 1134 rather than a prism. In such embodiments, projector 1132 can be located near the viewing surface of the lens and/or positioned such that a viewable image can be projected directly onto the viewing surface of lens 1134, rendering the image visible to the user.

In another aspect of display device 1120, input device 1150 can be mounted to frame 1122 at arm 1128 so as to overlay a portion of the side of a user's head. In alternative embodiments, input device 1150 can be mounted to frame 1122 in other locations. In particular, input device 1150 can be located at any portion of frame 1122 so as to be accessible to a user by feel rather than sight.

Input device 1150 can comprise a touchpad 1152 for sensing a position, pressure, or movement imparted by a user's finger via capacitive sensing, resistance sensing, or a surface acoustic wave process, among other possibilities. In this manner, touchpad 1152 can be configured to receive a variety of inputs or commands from the user.

Input device 1150, like display 1130, can be configured to wire- or wirelessly-communicate with receiver 1140 and on-board computing system 1142. In one embodiment, any input received at touchpad 1152 through contact with the user can be transmitted to receiver 1140 and commands can be relayed to camera 1144, display 1130, or any other components of head-mounted display device 1120.

In another aspect, head-mounted display device 1120 and/or receiver 1140 may comprise a GPS module for detecting the geographic location of a consumer wearing the device. In alternative embodiments, the geographic location of display device 1120 and the consumer wearing the device can be determined based, at least in part, on nearby wi-fi networks or cell phone signal triangulation. In further embodiments, the geographic location of display device 1120 can be determined using any suitable method.

In addition to display device 1120, FIG. 11 further depicts communication device 1160. In one aspect, communication device 1160 can be configured to wire- or wirelessly-communicate with one or both of head-mounted display device 1120 and identification unit reader 1110. For example, communication device 1160 may communicate with head-mounted display device 1120 or identification unit reader 1110 via a Bluetooth communication channel. In other embodiments, devices 1160 and 1120 can communicate via a RF or wi-fi communication channel. In further embodiments, the devices may communicate over some other wireless communication channel or a wired communication channel.

In another aspect, communication device 1160 can be a processor-based smart phone. In alternative embodiments, communication device 1160 can be any portable computing device such as a cell phone, a smart phone, a smart watch, a tablet, a laptop, or some other portable, controller- or processor-based device. In further embodiments, communication device 1160 can be any other portable or non-portable controller- or processor-based device, such as a desktop personal computer or a controller- or processor-based device built into a vehicle (e.g., a plane, train, car, etc.).

In still further embodiments, communication device 1160 is equipped with all components necessary to accomplish the methods and processes described herein. In such embodiments, head-mounted display device 1120 may not be necessary and system 1100 may comprise only communication device 1160 and identification unit reader 1110. In other embodiments, system 1100 may comprise communication device 1160 and one or more devices other than display device 1120.

As depicted in FIG. 11, communication device 1160 can comprise a computing system 1162 (not shown), a graphical display 1170, a menu button 1175, a microphone 1180, a forward-facing camera 1182, and a rear-facing camera 1184. In alternative embodiments, communication device 1160 can comprise fewer than all of the aforementioned components. In other embodiments, communication device 1160 can comprise additional components not expressly listed above.

In one aspect, computing system 1162 can be wire- or wirelessly-connected to other components of communication device 1160, such as graphical display 1170, menu button 1175, microphone 1180, forward-facing camera 1182, and/or rear-facing camera 1184. In another aspect, computing system 1162 can comprise a processor and memory, and may be configured to send, receive, and analyze data to and from other components of communication device 1160. Computing system 1162 may be further configured to send, receive, and analyze data to and from other devices, for example, head-mounted display device 1120 and/or identification unit reader 1110. An exemplary embodiment of computing system 1162 is discussed above and depicted in FIG. 2.

A user can control the functionality of communication device 1160 through a combination of user input options. For example, a user can navigate various menus and functions of communication device 1160 using display 1170 which can comprise a touchscreen 1172. Additionally, a user may input commands to communication device 1160 by pressing or tapping menu button 1175 or speaking into microphone 1180.

In a further aspect, communication device 1160 can comprise one or more cameras. For example, in one embodiment, communication device 200 can comprise a forward-facing camera 1182 and a rear-facing camera 1184. In one aspect, cameras 1182, 1184 can be any suitable camera configured to capture still images and video at one or more resolutions and/or frame rates. In particular, forward-facing camera 1182 may be configured so as to capture images and video representative of what a user is seeing or facing. Moreover, forward-facing camera 1182 can be in communication with computing system 1162 such that images or video captured by forward-facing camera 1182 can be transmitted to computing device 1162 for further processing. Likewise, information can also be transmitted to forward-facing camera 1182 from computing system 1162. Before, during, or after being transmitted to computing device 1162, any images or video captured by forward-facing camera 1182 can be transmitted to display 1170 for presentation to the user. For example, video captured by forward-facing camera 1182 can be transmitted to display 1170 for presentation to the user in real-time.

Likewise, rear-facing camera 1184 may be configured so as to capture images and video of the user's face or subjects located behind the user. For example, rear-facing camera 1184 can be configured to detect the user's eyes, the general direction in which the user is looking, and/or whether the user's eyes are in an open or closed state. This information can then be transmitted to computing system 1162 for suitable applications during which the user's eye direction or eye state may be desirable. Moreover, rear-facing camera 1184 can be in communication with computing system 1162 such that images or video captured by rear-facing camera 1184 can be transmitted to computing device 1162 for further processing. Likewise, information can also be transmitted to rear-facing camera 1184 from computing system 1162.

In the embodiment depicted in FIG. 11, communication device 1160 comprises a single forward-facing camera 1182 and a single rear-facing camera 1184. In alternative embodiments, communication device 1160 may comprise additional cameras, both forward- and rear-facing.

In another aspect, communication device 1160 may comprise a GPS module for detecting the geographic location of a consumer carrying or traveling with the device. In alternative embodiments, the geographic location of communication device 1160 and the consumer carrying or traveling with the device can be determined based, at least in part, on nearby wi-fi networks or cell phone signal triangulation. In further embodiments, the geographic location of communication device 1160 can be determined using any suitable method.

In use, a consumer wearing, carrying, or traveling with head-mounted display device 1120 and/or communication device 1160 comprising user identification unit 110 (as depicted in FIG. 1) may be detected by identification unit reader 1110. When user identification unit 110 and the consumer come in proximity to identification unit reader 1110, a handshake may occur enabling user identification unit 110 to transmit information to identification unit reader 1110. Numerous methods and communication channels are suitable to facilitate this exchange of information, and several methods and channels are discussed above. Additionally, any type of suitable information may be transmitted between user identification unit 110 and identification unit reader 1110. Examples of information that can be transmitted between the devices are described above.

In another aspect, all or a portion of the information transmitted to identification unit reader 1110 and/or other information gathered by one or more other components of system 1100 as described above, may comprise transaction information 500 to be transmitted to auction environment 430.

In a further aspect, once the consumer's presence is detected by identification unit reader 1110, and transaction information 500 is received and/or retrieved, advertising space at display 1130 of head-mounted display device 1120 or display 1170 of communication device 1160 may be made available for purchase through auction environment 430. The timing of when the advertising space may be made available within auction environment 430, how long the auction remains open for bids, when the advertisement of the winning bidder is displayed at display 1130 or display 1170, and how long the advertisement is displayed at display 1130 or display 1170 may be tailored according to the preferences of supplier 430 of the advertising space or some other party's preferences, and/or may be dictated by circumstances. Various possibilities regarding the timing of events are described above.

In one exemplary embodiment, where the consumer is detected entering a store in a shopping mall, the advertising space at display 1130 or display 1170 may be made available within auction environment 430 after the detection of the consumer by identification unit reader 1110, but not until the consumer's presence is detected again at some predetermined time later to ensure the consumer is engaged in shopping in the store and not simply passing through. For example, where the consumer's presence has been confirmed in the store three minutes after the first detection of the consumer within the store, the advertising space at display 1130 or display 1170 may be made available within auction environment 430. Of course, other embodiments are also possible and any predetermined time period, if applicable, may be shorter or longer than three minutes. The auction may then close to further bidding at a time determined by supplier 420, at some other time, or the closing of the auction may be triggered by an event.

After the auction closes, a winning bidder is determined and notified, and an advertisement is received, the advertisement may be displayed at display 1130 or display 1170 for viewing by the consumer while the consumer is shopping in the store. In particular, where the consumer is wearing or carrying head-mounted display device 1120, the advertisement may be displayed to the consumer in an augmented reality environment, superimposed over the consumer's field of view and/or at a location within the consumer's field of view that is predetermined or advantageous to the consumer, supplier 420, advertiser 440, marketing aggregator 460, or another party. Alternatively, the advertisement can be displayed to the consumer at display 1170 of communication device 1160. In particular, where video captured by forward-facing camera 1182 is displayed at display 1170 in real-time, an advertisement can displayed at display 1170 superimposed over the video representative of the consumer's field of view, thereby achieving augmented reality functionality.

The advertisement may also remain on display 1130 or display 1170 until, for example, the consumer is no longer detected within the store, until some predetermined time, or until the occurrence of some other event.

In this manner, an advertiser 440 or marketing aggregator 460 can specifically target a consumer, displaying an advertisement tailored to that consumer in light of information gathered regarding the consumer and his or her purchase habits, in conjunction with specific location information regarding that consumer.

All the embodiments described above can be used to detect a consumer in proximity to advertising space, receive or retrieve information associated with the consumer, transmit transaction information to an auction environment, and receive bids from advertisers for placing an advertisement at the advertising space. A method of use can comprise the provision of one or more of the devices described above, including but not limited to user identification unit 110, identification unit reader 120, and display 130.

Additional features can also be incorporated into the described systems and methods to improve their functionality. For example, where display 130 is incorporated into a head-mounted display device, a communication device, or a display within a vehicle of a consumer, the consumer may also be afforded an opportunity to respond to the advertisement by interacting with the head-mounted display device, communication device, or vehicle display. In such an instance, the advertisement may include numerous pieces of information, including but not limited to a phone number for the advertiser, an address for the advertiser, or a coupon for goods sold by the advertiser. The consumer may then enter commands or inputs to the head-mounted display device, communication device, or vehicle display to, for example, store the advertisers contact information, call the advertiser, receive turn-by-turn directions to the advertiser's place of business, redeem the displayed coupon, or otherwise interact with information contained in the advertisement. Alternatively, the consumer may enter commands or inputs to store information associated with the advertisement at the user identification unit for later retrieval.

Other embodiments will be apparent to those skilled in the art from consideration of the specification and practice of this disclosure. It is intended that the specification and examples be considered as exemplary only, with the true scope and spirit of the disclosure being indicated by the following claims.

What is claimed is:

1. A system for displaying an advertisement to a consumer, the system comprising:
a user identification unit storing information associated with a consumer, the physical location of the user identification unit being indicative of the physical location of the consumer; and
an identification unit reader in communication with a display comprising advertising space, the identification unit reader configured to:
receive the information associated with the consumer from the user identification unit when the user identification unit comes in proximity to the display;
transmit transaction information comprising the information associated with the consumer to an auction environment; and
transmit an advertisement for displaying at the display.

2. The system of claim 1, wherein the identification unit reader is further configured to retrieve second information from a database based at least in part on the information received from the user identification unit.

3. The system of claim 1, further comprising a second user identification unit storing information associated with a second consumer, wherein the identification unit reader is further configured to receive the information associated with the second consumer, and wherein the transaction information comprises information received from the user identification unit and the second user identification unit.

4. The system of claim 3, wherein the identification unit reader further determines common information from information received from a plurality of user identification units in communication with the identification unit, and wherein the transaction information includes the determined common information.

5. The system of claim 1, wherein the user identification unit comprises an RFID tag and the identification unit reader comprises an RFID reader.

6. The system of claim 1, wherein an advertising space aggregator receives the transaction information from the identification unit reader and transmits the transaction information to the auction environment.

7. The system of claim 1, wherein the transaction information comprises one or more of consumer identification information, consumer location information, consumer behavior information, consumer purchase history information, and display information.

8. A non-transitory, computer-readable medium containing instructions that, when executed by a processor, performs a method comprising:
detecting the physical presence of a user identification unit in proximity to an advertising space, the location of the user identification unit being indicative of the location of a consumer;
receiving consumer information associated with the consumer at an identification unit reader;
transmitting transaction information comprising at least a portion of the consumer information to a real-time auction environment where bids are received for placement of an advertisement at the advertising space;
receiving an advertisement for display at the advertising space; and
displaying the advertisement at the advertising space.

9. The non-transitory, computer-readable medium of claim 8, further comprising closing the auction to the submission of further bids after detecting the physical presence of the user identification unit within a line of sight of the advertising space.

10. The non-transitory, computer-readable medium of claim 8, further comprising receiving ancillary information associated with the advertisement.

11. The non-transitory, computer-readable medium of claim 10, further comprising transmitting the ancillary information to an ancillary display associated with the consumer.

12. The non-transitory, computer-readable medium of claim 11, further comprising receiving input from the consumer associated with the ancillary information.

13. The non-transitory, computer-readable medium of claim 11, further comprising:
detecting the physical presence of a second user identification unit in proximity to the advertising space, the location of the second user identification unit being indicative of the location of a second consumer; and
receiving second consumer information associated with the second consumer at the identification unit reader,
wherein the transaction information further comprises at least a portion of the second consumer information.

14. A method for displaying an advertisement to a consumer, the method comprising:
receiving information associated with a consumer at an identification unit reader when a user identification unit comes in proximity to the identification unit reader;
transmitting at least a portion of the information to one or more advertisers or marketing aggregators participating in an auction where bids are received for placement of an advertisement at the advertising space;
receiving an advertisement for display at the advertising space; and
displaying the advertisement at the advertising space.

15. The method of claim 14, wherein the advertising space is located at a portable display associated with the consumer.

16. The method of claim 15, wherein the advertisement is superimposed over the consumer's field of view.

17. The method of claim 15, wherein the advertisement is superimposed over a video signal representative of the consumer's field of view.

18. The method of claim 17, further comprising receiving ancillary information associated with the advertisement.

19. The method of claim 18, further comprising transmitting the ancillary information to the consumer.

20. The method of claim 18, further comprising transmitting the ancillary information for display to the consumer at one of the advertising space and an ancillary display.
